(19) United States
(12) Patent Application Publication
(10) Pub. No.: US 2011/0304854 A1
(43) Pub. Date: Dec. 15, 2011

(54) INSTANTANEOUS, PHASE MEASURING INTERFEROMETER APPARATUS AND METHOD

(76) Inventor: Si Li, Webster, NY (US)

(21) Appl. No.: 13/157,869

(22) Filed: Jun. 10, 2011

Related U.S. Application Data
(60) Provisional application No. 61/354,698, filed on Jun. 14, 2010.

(51) Int. Cl. G01B 11/02

(52) U.S. Cl. 356/496

(57) ABSTRACT

The present invention generally relates to measuring and testing in the area of optics, and more specifically to a plurality of interacting coherent light beams to produce a cancellation or reinforcement of wave energy for measuring or testing. The present invention is directed to an improved interferometer system wherein a measurement is derived from phase measurements, wherein measurements include: distance, angular speed, as well as other physical or metrological properties. The present invention includes an interferometer that uses an illumination source comprised a plurality of simultaneously activated laser beams, each possessing a different wavelength contained in a coherent composite laser beam.

### RELATED APPLICATIONS AND PRIORITY CLAIM

This application claims priority to provisional application U.S. Ser. No. 61/354,698 filed in the name of Si Li of Webster, N.Y. (USA), on Jun. 14, 2010. This application is incorporated by reference herein in its entirety.

### FIELD OF THE INVENTION

The present invention generally relates to measuring and testing in the area of optics, and more specifically to a plurality of interacting coherent light beams to produce a cancellation or reinforcement of wave energy for measuring or testing. The present invention is directed to an improved interferometer system wherein a physical measurement, such as distance, is based on phase measurements.

### BACKGROUND OF THE INVENTION

Phase Measuring Interferometry can be implemented in two ways, instantaneous measurement or sequenced interference measurement (phase scanning measurement).

### Phase Scanning Measurement Method

To obtain interference based phase measurement from a group of the interacting light sources, the sources must either possess different wavelengths or if the light sources have the same wavelength, there must exist a phase difference related to the test and reference objects, or a test point and reference point.

One scanning method can be implemented by moving either the reference surface or the test surface along the laser traveling direction by the distance of a portion of the laser wavelength and then repeating the movement in desired steps. The measurement results in a sequence of intensity data. Applying Fourier analysis to the data will lead to a phase value, which is a presentation of the distance between the test and reference surfaces.

An imaging system is typically included in the measuring process. Imaging systems that include a collimator and intensity sensor array enables the setup to measure two-dimensional parts.

The error sources of the scanning measurement method come from the following aspects:
1. Mechanical oscillation
2. Imperfect shifting steps
3. Laser source intensity and frequency drifting
4. The drifting of the gain and offset of the sensors
5. Air turbulence
6. Stray reflections
7. Non-linearity of the sensors
8. Random intensity errors

If the setup includes an imaging system, additional sources of error are introduced that can cause non-parallel wave front errors between each shifting step. Although phase shifting can be implemented using a variety mechanisms, including: Bragg cells, diffraction gratings, or tilted glass plates, they, unfortunately, all suffer from similar errors.

Compared to the normal incidence Phase Shifting Interferometry, the laser beam can also travel at an angle relative to the test-reference or test point surface or surfaces. With a known normal distance between the test and reference flat surfaces, an angle change of the laser beam produces a phase difference or phase shift can be calculated. This method reduces certain types or errors, but introduces new errors, such as position sharing errors. Overall, the number of source errors remains approximately the same, although it offers more flexibility in expanding the measuring range by changing the effective wavelength. The technique it has its own limitation, in that only near-flat surfaces can be measured.

### Instantaneous Phase Measurement Method

The instantaneous phase measurement method was developed to measure multiple interferences at the same time. Usually, four interferences with 90-degree phase differences from each other are measured. Since there is no time delay between the measurements, the influence of vibration, drifting, air turbulence, frame-depending random error, and the like, is significantly reduced. However, the imperfect shifting steps errors are still present. Polarizing methods are often used to separate those beams with respect to a phase difference; thereby placing a limit on the number of frames available. The correction compensation of the non-linearity error or random intensity type error usually requires more interference data for proper compensation. Therefore, instantaneous methods reduce some errors but increase others. Additionally, the compensation of imperfect shifting likewise requires more measurements; the contribution of remaining aforesaid system errors will likely result in unacceptable, inaccurate metrological measurements.

There are two different ways to apply the instantaneous method to measure a two-dimensional part. One way is to use multiple two-dimensional sensor arrays to measure the interferogram patterns at the same time. This allows the whole part to be measured at the same time. The problem with this method is that the multiple CCDs and the separation of the beams require a very complex imaging system. In this system, it is difficult to guarantee that each beam with a different phase difference has a parallel wave front. And the distorted interferogram patterns lead to measurement distortion. There is also technology that separates the beams locally, using a local filter map and a high resolution CCD to obtain multiple 2-D interferogram patterns. This method suffers from similar problems when wavefronts distort. Another disadvantage of this method is that it is difficult to vary the resolution of the measurement. A zooming system will make the image system more complex and introduce additional distortions.

Another way to implement an instantaneous measurement is to measure a single point at a particular moment in time, followed by subsequent surface scans of different test point on the test part; such single point scans will continue until the test part surface is substantially analyzed. In this case, the beams separation mechanism needs not to be combined with the imaging system like collimators and CCDs. The measurement will also have distortion problems because of slow drifting due to the environment conditions during scanning over the test region, (single point measurement is not affected by the drifting). One advantage of this implementation is that it is easy to control the sampling rate when scanning the test part, which makes it easy to change the resolution of the measurement.

Common Problems Associated with the Scanning and the Instantaneous Measurement Methods

Both phase measurement interferometry methods discussed above, scanning interferometry and instantaneous interferometry, share the same limitation: a very short unambiguous measuring range. It is usually the half distance of the laser source's wavelength.

If the test object has a relatively smooth surface and does not have multiple sub-surfaces with a step-like depth jump, a phase-integration method or phase unwrapping method can be used to construct a continuous phase surface without any two-PI jump. If the test part is not smooth enough (the local roughness is close to a quarter of the laser wavelength or larger) the unwrapping will fail. If the step height of the sub-surface is larger than a quarter of the laser wavelength, then the depth will be ill-presented.

To extend the measuring range, a second laser source with a different wavelength can be introduced to form a larger synthetic wavelength. For example, a first wavelength λ₁ and a second wavelength λ₂ can function together to form a synthetic wavelength, wherein the new wavelength is calculated by the following equation:

$${λ}_{s} = \frac{{λ}_{2} \times {λ}_{1}}{\vert {λ}_{2} - {λ}_{1} \vert} .$$

With the second laser source, the device becomes more complex because of the required second set of phase measuring components, in addition to necessary beam aligning components. It is very important that the corresponding sensors in the two different wavelength systems are aimed at the exact same position or test point of the test part. The previous mentioned non-normal incidence interference may generate a lager “virtual wavelength”, but it can only increase the apparent wavelength by several times, and it unfortunately also increases the associated errors.

The smaller the difference between the two laser's wavelengths, the longer the synthetic wavelength will be. However, in conventional two-wavelength systems, the synthetic wavelength produced is usually very limited. The limitation is primarily due to the errors associated with the two fundamental laser signals, wherein the errors are amplified when combined. If the synthetic wavelength generated is M times longer than the average of the two fundamental wavelengths, the error will also be M times larger.

To keep the accuracy of the measurement to the fundamental wavelength measurement, the error in the synthetic signal cannot exceed one half of the fringe (a quarter of the laser wavelength) of the fundamental signal. In this case, the synthetic phase structure can be used to determine the fringe number of the fundamental phase structure. In another words, it can be used to help unwrap the fundamental phase map.

In summary, the two-wavelength phase measuring interferometry suffers from several shortcomings, its complexity, its limitation in expanding the measuring range, and the possible significant increase in error.

### Recent Technology Review on Wavelength Scanning Interferometry

The use of tunable laser is a relative new device in the area of interferometry. The previously mentioned angle changing methods can vary the effective wavelength, but the angle shift must be kept very small to prevent the generation of significant sharing errors. Tunable lasers can offer more steps of interference, each step with a constant frequency change. The resulting intensity measurement, just like a sequence of phase shifting, shows a sinusoid periodic pattern. The phases of the sinusoid periodic functions represent the distances between the reference or reference point and test part or test point, which are the same distances as in the phase shifting method. However, in the wavelength tuning case, the phase difference of each step is also a function of the distance.

It means the total phase difference between the start and the end of the intensity data sequence is also a function of the distance, just like the starting phase value. The two (starting—phase to distance and starting-ending phase difference to distance) functions have significant sensitivity differences; it means the two-PI difference in the latter function represents a much longer distance. Since the starting-ending phase difference is in fact the cycle number multiplied by the two-PI value, it is equivalent to the frequency of the dataset. Naturally, it is commonplace to use a Fourier Transform analysis to obtain the value.

The maximum value of the adjacent phase-difference is two-PI, but under the Fourier analysis method, only half of it is distinguishable. Therefore the maximum measuring range is limited to PI, and is determined by the frequency difference step of the laser tuning. The smaller the frequency step, the lager the measuring range. The resolution, or the accuracy of the measurement, is determined by the entire tuning range of the laser. The bigger the starting-ending frequency difference, the finer the resolution will be.

The starting point's phase is equivalent to the result of phase shifting method. Both have two-PI values corresponding to half of the laser wavelength. Ideally, one can use the phase difference function output to determine the fringe number of the phase function; therefore, the tunable laser interferometry will have the ability to measure a long range with small error.

For example, if the tunable laser's tuning step is 50 GHz, the Fourier analysis function will give a roughly 1.5 millimeter measuring range. If the laser has a wavelength of 1550 nm, the phase-distance function has a range of 755 nm. If Fourier analysis can resolve the number of cycles to accuracy equivalent to 327 nm of distance, then the phase-distance function can refine the result to accuracy within nanometers.

The problem with this technology is that the error sources in the phase shifting methods still exist. Furthermore, the problems stemming from the Fourier analysis such as frequency dispersion, phase changing ripples, and windowing distortion make the determination of an accurate phase-difference more difficult.

Some efforts have been made using additional cosine-fitting methods after the Fourier transform to determine the fringe number of the phase function. The result is not satisfactory because it is also sensitive to random noise and systematic drifting.

The wavelength scanning method usually takes more steps than in the conventional phase changing (scanning) method to increase resolution and accuracy. It is therefore very difficult to perform an instantaneous two-dimensional measurement because it is impossible to handle such complex imaging systems.

Scanning over many wavelengths with a single imaging system shares the same error sources with the phase shifting technology. Since there are more steps to scan, the non-parallel wave front drifting will become a more serious problem. And because a scan will require a longer period of time to complete, air turbulence and electrical drifting type errors start becoming significant. In addition, methods utilizing long measuring ranges are prone to mechanical oscillation type errors.

### DISCUSSION OF RELATED REFERENCES

U.S. Pat. No. 7,898,669B2 to Kim et al., describes a relatively complex system that introduces a femto-second laser comb as the interferometric light source. The proposed comb is pulse based, thereby requiring the need for phase lock loops. Additionally, the system contains all the phase shifting devices required to measure the phase of each beam of particular wavelength. Because the described method uses a wavelength scan, it cannot measure the sample instantaneously.

In U.S. Patent Application Pub. No. 2010/0225924 A1 to Kuramoto, another comb based multiple wavelength interferometry method is proposed. Instead of one comb, this method requires two combs, which are polarizing in orthogonal directions. This makes both the source and the detecting devices very complex. It also has all the phase shifting devices in their proposed system. Furthermore, it requires specific reflecting device to be mounted on the target that need to be measured, which is very impractical.

Both of the aforementioned references use combs where the beams or test beams are separated by the exact same frequency difference.

### SUMMARY OF BACKGROUND TECHNOLOGY

Other than phase shift method, phase modulation is also used to help measure phase. However, phase modulation is a time consuming process and cannot be accomplished instantaneously, therefore does not lend itself to instantaneous Phase Measuring Interferometry.

Although phase-shifting methods with 4 steps can be accomplished instantaneously, it requires many additional parts and setups that leads to a very complex system.

Some interferometric systems that use more wavelengths fall into category of synthetic wavelength Interferometry. These synthetic wavelength based systems suffer from similar issues and drawbacks as the phase-shifting and phase modulation based interferometry systems described above. The phase-shifting, phase modulation, and synthetic wavelength types of interferometry shall be collectively identified by the term or phrase “phase manipulated”. Likewise, the term non-phase manipulated, or not phase manipulated (as it pertains to interferometric systems), excludes those systems utilizing phase-shifting, phase modulation, and synthetic wavelength type processes or techniques.

Accordingly, in view of the foregoing deficiencies, there is a need in the interferometry field for new and useful improvements.

### SUMMARY OF THE INVENTION

The present invention is directed to a system having an instantaneous implementation based on a multiple wavelength source. The present system differs from those included in the aforementioned discussion in several aspects. Differences include the use of a continuous-wave laser beam, where no phase locking device is required. Another is the use of a single test group to obtain an instantaneous measurement. Additionally, the interference phase of each beam can be calculated without the use of any phase shifting or phase modulating type devices.

This invention is based on a method that measures the difference of two light paths, a reference path and a test path, by calculating the phases and phase differences of a group (or groups) of interfered signals. The signals are formed by a group (or groups) of simultaneously present multiple-wavelength laser beams interfering over the above-mentioned paths.

This method differs from the wavelength-scanning method because it obtains all the interference data at the same time. It differs from the conventional simultaneous phase measuring interferometry because it does not use phase delay beams of the same wavelength. Instead, it compares the interfered data of different wavelengths. It differs from the synthetic wavelength method that uses two wavelengths because it uses many more beams. The wavelength variation of these beams has a certain pattern that is explained below.

The laser beams may be in one group or more groups. Within each group, there is a constant frequency difference (frequency step) between each beam and its neighbor, or there is a known and stable frequency structure that is close to even frequency distribution. There should be sufficient number of beams in each group (for example, around 20) to form a periodic measurement pattern. The frequency step of each group should be the same and should be small enough to form an extremely long synthetic wavelength. The frequency changes between groups may or may not be the same. The frequency difference between the first and the last group should be large enough so that the synthetic wavelength formed by the first beam of first group and last beam of last group would be relatively small.

Each test beam should be aligned to measure the exact same point and interfering only with the reference beam with the same wavelength. After interfering, the beams should be separated by wavelength, with one beam for each wavelength. When the beams are combined into one single-mode optical fiber, they are all automatically aligned. And there are many commercially available fiber based devices to combine and separate the beams.

The system apparatus of the present invention, in collaboration with cooperating algorithms, control software, and the like, can attain a measuring range of many millimeters with sub-nanometer measurement accuracy in many real world industrial environments.

For the distance measuring application, this invention also includes the devices and designs that implement the above-mentioned system. The device should have three major components: multiple wavelength beams generating component, interference generating component, and beams separation component. There are many embodiments with different design details in the above-mentioned components and different moving-error compensation devices to measure a variety of one, two, or three-dimensional objects. An exemplary design for the measurement of such objects is included in the forthcoming discussion.

Thus, having broadly outlined the more important features of the present invention in order that the detailed description thereof may be better understood, and that the present contribution to the art may be better appreciated, there are, of course, additional features of the present invention that will be described herein and will form a part of the subject matter of the claim(s) appended to this specification.

In this respect, before explaining at least one embodiment of the invention in detail, it is to be understood that the invention is not limited in its application to the details of construction and the arrangements of the components set forth in the following description or illustrated in the drawings. The present invention is capable of other embodiments and of being practiced and carried out in various ways.

As such, those skilled in the art will appreciate that the conception, upon which this disclosure is based, may readily be utilized as a basis for the designing of other structures, methods and systems for carrying out the several purposes of the present invention. It is important, therefore, that the description be regarded as including such equivalent construction insofar as they do not depart from the spirit and scope of the conception regarded as the present invention.

### ADDITIONAL ADVANTAGES AND FURTHER SUMMARY OF THE INVENTION

In the present invention, the laser source or coherent composite laser beam powering the interferometer contains a plurality of simultaneously active coherent laser beams that form a test laser group. Each individual coherent laser beam is a continuous wave. It is not a requirement that each individual coherent laser beam in the test laser group have to be equally separated by a constant frequency difference to function.

There is no phase shifting or phase modulating device required in the present invention to enable the calculation of phase.

For metrological analysis, it is not necessary to include all the intensity related phase information of each individual coherent laser beam in the test laser group. The present invention enables metrological analysis given a portion of the individual coherent laser beam intensity phase information contained in the test laser group; e.g. the intensity difference of a given beam and just its neighbor beams.

The method for metrological analysis includes two fundamental steps. The first is to estimate a proximate target distance. The second is to refine the distance with phase value of each beam. Many statistic methods can be used as first step, for example, a regression between the intensity and its special derivative can lead to a good estimation. Then an iteration process with triangular calculation can lead to refined phase value for each beam.

### BRIEF DESCRIPTION OF THE DRAWINGS

The invention will be described by reference to the specification and the drawings, in which like numerals refer to like elements, and wherein:

FIG. 1, a graph illustrating the spectrum of an exemplary test group having two sub-groups constructed from a plurality of simultaneously active coherent laser beams having essentially equal frequency differential increments. The co-joining of the plurality of simultaneously active coherent laser beams produces a coherent composite laser beam.

FIG. 2, a graph illustrating the spectrum of an exemplary test group (possessing several sub-groups) constructed from a plurality of simultaneously active coherent laser beams wherein all beams possess substantially unequal frequency differential increments. The co-joining of the plurality of simultaneously active coherent laser beams produces a coherent composite laser beam.

FIG. 3, a configuration diagram illustrating one embodiment for generating a coherent composite laser beam using a plurality of laser diodes system, which includes a fiber optic coupling device.

FIG. 4, a configuration diagram illustrating one embodiment for generating a coherent composite laser beam using at least one single-mode laser diode and a nonlinear optical phase modulator; thereby creating one or a group of CW (continuous wave) Comb(s).

FIG. 5, flow chart-block diagram illustrating the primary subsystems and information flow comprising an exemplary instantaneous, phase measuring interferometer.

FIG. 6, a system configuration diagram—illustrating one embodiment of an exemplary instantaneous, phase measuring interferometer setup for analyzing a transparent test part using a probe.

FIG. 7, a configuration diagram illustrating one embodiment of an exemplary instantaneous, phase measuring interferometer setup for analyzing a test part using a free space beam splitter.

FIG. 8, a configuration diagram illustrating an exemplary setup for deconvoluting an interferometric beam into a plurality of constituent beams based on frequency using a wavelength division multiplexer (e.g. CWDM, or DWDM), followed by a fiber-coupled photo-diode array for detecting a plurality of intensity measurements.

FIG. 9, a configuration diagram illustrating an exemplary setup for deconvoluting an interferometric beam into a plurality of constituent beams based on frequency using a diffraction prism or a diffraction grating, followed by a fiber-coupled photo-diode array for detecting a plurality of intensity measurements, and a data acquisition system.

FIG. 10, a configuration diagram illustrating one embodiment of an exemplary instantaneous, phase measuring interferometer setup for analyzing a transparent test part using a simple (compact) probe utilizing a GRIN collimator.

FIG. 11, a configuration diagram illustrating one embodiment of an exemplary probe cylinder including a GRIN or Asphere lens, and a beam splitter.

FIG. 12, a configuration diagram illustrating one embodiment of an exemplary instantaneous, phase measuring interferometer setup for analyzing a test part surface, where the setup includes a single-mode fiber coupler that functions as a beam splitter for test and reference probes.

FIG. 13, a configuration diagram illustrating an embodiment of a one dimensional scanning means including a probe carrier supporting a simple or compact probe.

FIG. 14, a configuration diagram illustrating an embodiment of a one dimensional scanning means including perpendicular reference mirrors, a probe carrier supporting multiple reference probes.

FIG. 15, a configuration diagram illustrating an embodiment of a two dimensional scanning means including a planar calibrated reference mirror, a probe carrier supporting an exemplary probe, and a two dimensional test part.

FIG. 16, a configuration diagram illustrating an embodiment of a probe carrier supporting three probes mounted at different angles to the test part. Two of the three probes are utilized in the stage-moving-error-correction configuration of the probe carrier setup.

FIG. 17, a configuration diagram illustrating an embodiment for delivering a portion of a coherent composite laser beam to a plurality of compact probes and forwarding the resultant group of constituent interferometric beams to a detecting means by the utilization of a high speed switch.

FIG. 18, a configuration diagram illustrating one embodiment of an exemplary instantaneous, phase measuring interferometer setup for analyzing a test part using a simple (compact) probe and a (slightly) tapered transparent reference plate positioned between the probe and the test part.

FIG. 19, a graph illustrating an exemplary result of group of constituent interferometric beams, where normalized intensity is plotted with respect to frequency.

FIG. 20, a flowchart illustrating an exemplary method for phase calculation.

The drawings are not to scale, in fact, some aspects have been emphasized for a better illustration and understanding of the written description.

In order to help facilitate the understanding of this disclosure, a parts/features list numbering convention has been employed. The first digit in three digit part numbers refers to the Figure number and/or Figure number family where the part was first introduced, or is best depicted. Likewise, in four digit part numbers, the first two digits refer to the Figure number where the part was first introduced, or is best depicted. Although this disclosure may at times deviate from this convention, it is the intention of this numbering convention to assist in an expeditious comprehension of the present invention.

### PARTS/FEATURES LIST

100—graph—exemplary Coherent Composite Laser Beam configured from an exemplary Test Group having two Sub-groups
102—First sub-group comprising test group
104—Second sub-group comprising test group
106—Exemplary active coherent laser beam (center)
108—Exemplary active coherent laser beam (right)
110—Exemplary active coherent laser beam (left)
112—beam 106 and beam 108 frequency differential
114—sub-group 102 and sub-group 104 frequency differential
116—laser beam (first sub-group—last beam)
118—dissimilar frequency differential increment
120—laser beam (second sub-group—first beam)
200—graph—frequency spectrum of an exemplary test group having uneven frequency separation between coherent laser beams
300—configuration diagram—an exemplary plurality of laser diodes system for producing a coherent composite laser beam
302—CWDM or DWDM Multiplexer module
304—laser diode array
306—Integrated heat sink
308—TEC—Thermo Electric Controller
310—Laser Power Supply
312—Laser diode driving boards with optional power feed-back control
314—Optional power feed-back control system
316—Coherent composite laser beam
400—Exemplary configuration—illustrating an exemplary system for generating a coherent composite laser beam comprising at least one single-mode diode and a CW comb
402—Laser diode driving boards with optional power and/or temperature feed-back control
404—One or more single mode laser diodes
406—Laser diode frequency and power monitor—optional single mode laser diode output measuring system, for monitoring output frequency and power to enable feed-back control
408—WDM (Wavelength Division Multiplexer) fiber filter
410—CW Comb Generating nonlinear phase modulator
412—High frequency voltage driving device
414—Coherent composite laser beam
500—A flowchart detailing primary subsystems comprising an instantaneous phase measuring interferometer
502—Coherent composite laser beam generating system
504—Interferometric beam generating system
506—Interferometric beam separation device—system for converting interferometric beams to a group of constituent beams based on frequency
508—Data acquisition system, a system for detecting, measuring, storing, and analyzing Interferogram data
600—Interferometer system—an exemplary setup for the analysis of a transparent test part
602—Fiber optic coupler
604—Measurement probe
606—Transparent test part
700—interferometer system—another exemplary interferometer system setup for analyzing a test part surface utilizing a reference point or surface located on a calibrated reference element
702—emitting probe
704—beam splitter
706—reference surface or point
708—test part
710—receiving probe
800—system for deconvoluting the interferometric beam
802—Wavelength Division Multiplexer
804—current signal collecting board
806—array of photodiodes
900—Another exemplary interferometer system setup for interferometric beam
902—optical diffraction prism
903—optical diffraction grating
904—beam collimator
906—photo-diode sensing array
910—data acquisition system—a system for storing, and analyzing Interferogram data
1000—interferometer system for analyzing a transparent test part using a simple probe
1004—simple or compact probe
1006—fiber coupler
1008—fiber ferrule
1010—GRIN collimating lens
1012—test part
1100—a simple probe (alternate embodiment)—having a built in beam splitter, exemplary interferometer setup
1104—fiber connected ferrule
1106—focusing lens (GRIN collimating lens or asphere lens)
1108—beam splitter
1110—reference surface
1112—aperture
1200—exemplary interferometer setup or system
1202—wideband isolator
1204—2×2 single-mode fiber coupler
1206—reference probe
1208—test probe
1210—reference mirror
1212—test part
1300—exemplary one dimensional scanning apparatus
1302—reference object
1304—probe carrier driving/guiding apparatus
1306—probe carrier or moving stage
1308—test part
1310—reference probe
1312—test probe
1400—two dimensional scanning apparatus—having multiple reference probes
1402—first reference mirror, parallel with Y-axis
1404—second reference mirror, parallel with X-axis
1405—test part in flat orientation
1406—test part in angled orientation
1408—test probe
1410—probe carrier or moving stage
1412—probe carrier driving/guiding apparatus
1414—reference probe(s)
1500—two dimensional scanning apparatus
1502—planar calibrated reference mirror
1504—planar or two dimensional test part
1506—probe carrier or moving stage
1508—test probe
1510—reference probe
1512—probe carrier driving/guiding apparatus, parallel with X-axis
1514—probe carrier driving/guiding apparatus, parallel with Y-axis
1600—probe carrier embodiment—supporting three reference probes
1601—first reference probe
1602—second reference probe
1603—third reference probe
1604—probe carrier or moving stage
1606—first test probe
1608—second test probe
1700—high speed switch beam management system
1702—array of probes
1704—laser source high speed switch
1706—detector high speed switch
1800—exemplary instantaneous, phase measuring interferometer—having a tapered transparent reference plate positioned between the probe and the test part
1802—fiber coupler
1804—collimator
1806—tapered transparent reference plate
1808—test part
1900—graph illustrating the intensity of the group of the constituent beams (normalized intensity is plotted with respect to frequency)
2000—flowchart—method for determining phase
2002—retrieve interferometric intensity data
2004—normalize the intensity data for each wavelength
2006—run a statistical method; get an estimation of the distance
2008—calculate the phase separation between channels based on the estimation
2010—calculate the phase of each channel
2012—refined distance value from phase analysis
2014—calculate desired metrological value(s)

### DEFINITIONS OF TERMS USED IN THIS SPECIFICATION

The instantaneous, phase measuring interferometer apparatus and method, including the various embodiments disclosed, shall have equivalent nomenclature, including: the interferometer technology, the improved interferometer, the device, the embodiment, the present invention, or the invention. Additionally, the term “exemplary” shall possess only one meaning in this disclosure; wherein the term “exemplary” shall mean: serving as an example, instance, or illustration.

The term coherent composite laser beam shall include the meaning wherein a multitude of simultaneously active coherent laser beams are optically combined such that the coherent composite laser beam assumes the appearance of a single beam of coherent laser light. The multitude of simultaneously active coherent laser beams may or may not include any sub-groups.

The phase-shifting, phase modulation, and synthetic wavelength types of interferometry shall be collectively identified by the term or phrase “phase manipulated”. Likewise, the term non-phase manipulated, or not phase manipulated (as it pertains to interferometric systems), excludes those systems utilizing phase-shifting, phase modulation, and synthetic wavelength type processes or techniques.

### DETAILED DESCRIPTION OF THE INVENTION

This section is divided into two main sections, section 1 will sequentially review the details of the figures of the present invention; followed by section 2, which will further elaborate on the details of the present invention.

### Section 1

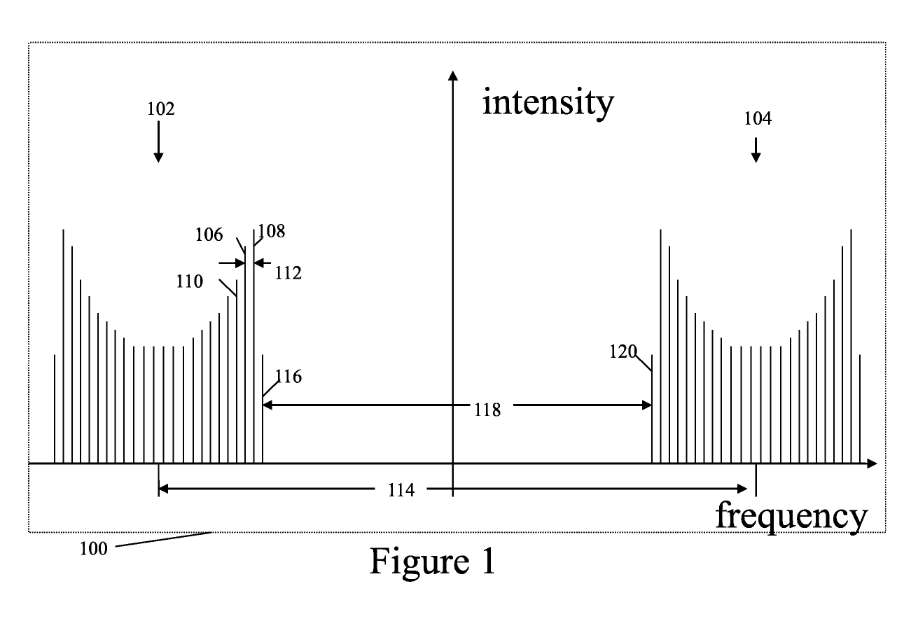

Referring to FIG. 1, the figure depicts graph 100—illustrating the spectrum of an exemplary test group having two sub-groups that comprise an exemplary Coherent Composite Laser Beam. First sub-group 102 is comprised of a plurality of active coherent laser beam, including exemplary active coherent laser beams 104, 106, 108, 110, 116; likewise, second sub-group 104, possesses exemplary active coherent laser beam 120. Each of the simultaneously active coherent laser beams possesses a unique operating frequency and a substantially constant intensity output (intensity levels among the individual outputs need not be equal).

The array of simultaneously active coherent laser beams shown in graph 100 depict a crescendo of unique operating frequencies each having a frequency differential increment 112, determined by the frequency difference between a unique operating frequency 106 and the consecutively higher unique operating frequency 108; thereby creating a plurality of frequency differential increments.

The laser test group containing all the active coherent laser beams depicted in graph 100, is required to have at least one dissimilar frequency differential increment 118 that differs in frequency magnitude or frequency step from remaining plurality of frequency differential increments (which are all substantially equal). In graph 100, a dissimilar frequency differential increment 118 is created by the frequency differential between laser beam 120 and laser beam 116. It is such a dissimilar frequency differential increment 118 that defines the number of sub-groups (e.g. 102, 104) contained in a given test group. First sub-group 102 and second sub-group 104 form the test group that is wholly contained in graph 100. In the present example, first sub-group 102 and second sub-group 104 are separated by an arbitrary sub-group frequency differential 114.

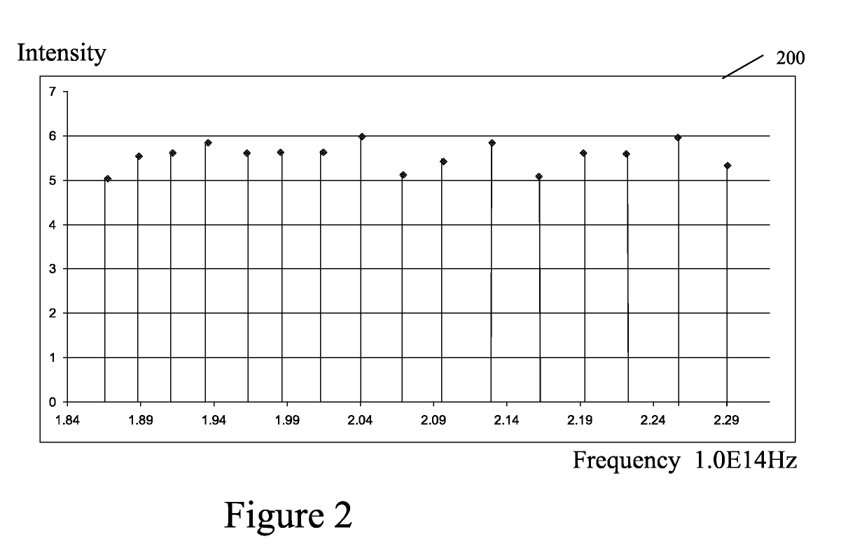

Referring to FIG. 2, the figure depicts graph 200—illustrating the frequency spectrum of an exemplary test group having uneven frequency separation among all coherent laser beams. In this particular example, 16 sub-groups are depicted, each possessing one laser beam therein. The co-joining or combination of the plurality of simultaneously active coherent laser beams depicted in FIGS. 1 and 2 is the substructure responsible for the creation of the corresponding coherent composite laser beams.

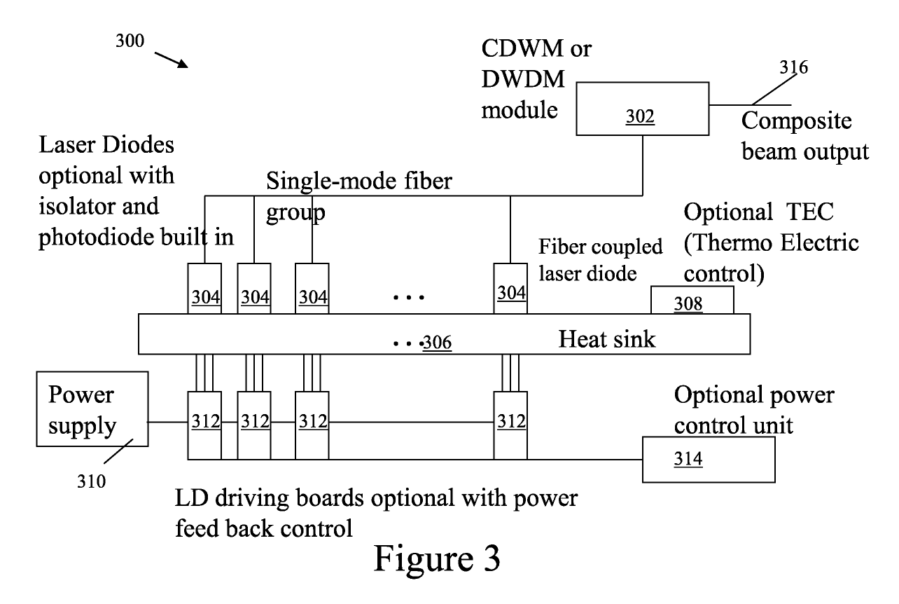

Referring to FIG. 3, the figure depicts configuration diagram 300, illustrating one embodiment for generating a coherent composite laser beam using a plurality of laser diodes system, which includes a fiber optic coupling device. Laser diode array 304 is comprised of individual single mode laser diodes. Exemplary laser diodes include: DFB type laser diodes with monitoring photodiodes with built-in isolator with optional thermal controller; another example includes a laser diode coupled with a single-mode fiber.

CWDM or DWDM Multiplexer module 302 provides the beam-combining function required to create coherent composite laser beam 316. Exemplary modules include passive Wavelength Division Multiplexers of either the coarse or dense variety.

Integrated heat sink 306 is a single, thermally continuous heat sink where the plurality of laser diodes 304 are attached. A single heat sink type of configuration helps insure that all of the attached laser diodes experience essentially the same temperature drifting effects, thereby reducing the thermal error contribution portion of the total system error. Optional TEC (Current and temperature controller) 308 attached to integrated heat sink 306 is useful when the system is used in an environment having large temperature swings.

Laser diode driving boards 312 powers the plurality of laser diodes 304 and can optionally include power feed-back control 314. The feed-back control can monitor and control the current and power so to stabilize laser output power. Laser Power Supply 310 provides the power necessary to energize the laser diode driving boards 312.

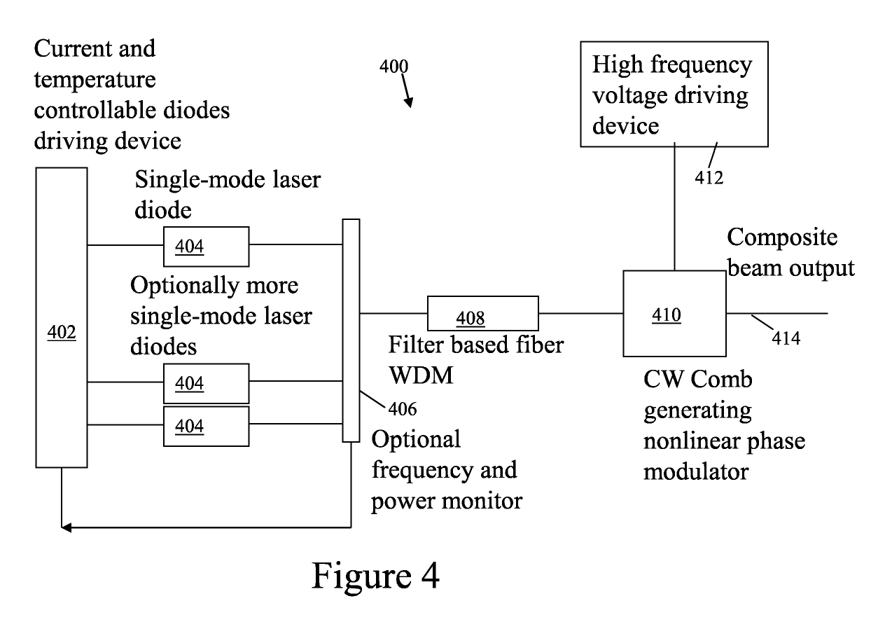

Referring to FIG. 4, the figure depicts an exemplary configuration 400, illustrating a system for generating a coherent composite laser beam 414. The system includes one or more single mode laser diodes 404, powered by laser diode driving boards 402 optionally including power and/or temperature feed-back control system. Single mode laser diodes 404 have no common like laser diode array 304 of FIG. 3, instead, each diode 404 contains a built in thermo-control device, and additionally includes a fiber optic coupling device.

Laser diode frequency and power monitor 406 is an optional laser diode output measuring system. Monitor 406 can be configured with a slight tilted cavity gap having a parallel sensor array. The readings obtained from monitor 406 can feed a signal to laser diode driving boards 402, thereby forming a feedback loop capable of controlling temperature and current of single mode laser diodes 404; thereby resulting in laser outputs having stable frequency and power characteristics.

WDM (Wavelength Division Multiplexer) fiber filter 408 serves to combine the laser output signals of single mode laser diodes 404.

CW-Comb generating device 410 is a generating nonlinear phase modulator. CW-Comb 410 can contain a variety of nonlinear devices, including Lithium Niobate crystal based device or the like. High frequency voltage generating device 412 drives the nonlinear crystal system contained in CW-Comb 410. For example, a couple of typical operating points include 50 or 100 GHz input signals.

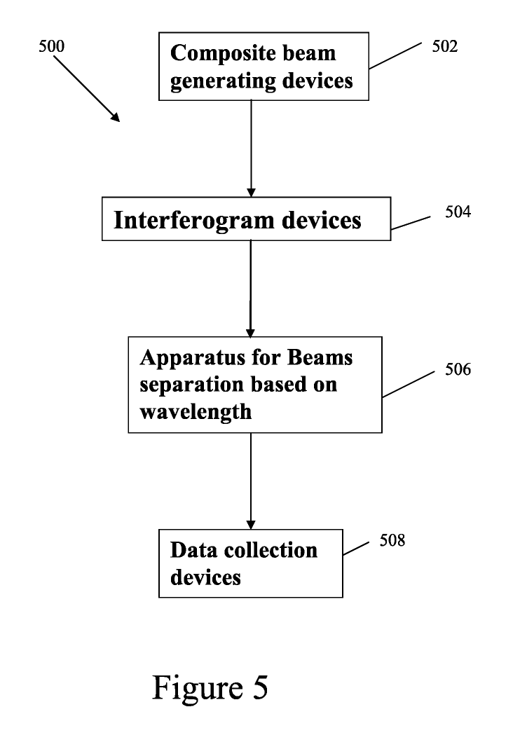

Referring to FIG. 5, the figure depicts an exemplary flowchart 500, illustrating the primary subsystems and signal/information flow comprising an instantaneous, phase measuring interferometer. Coherent composite laser beam generating system 502, provides a working laser signal or a coherent composite laser beam to interferometric beam generating system 504. Exemplary coherent composite laser beam generating systems 502 are depicted in FIGS. 3 and 4.

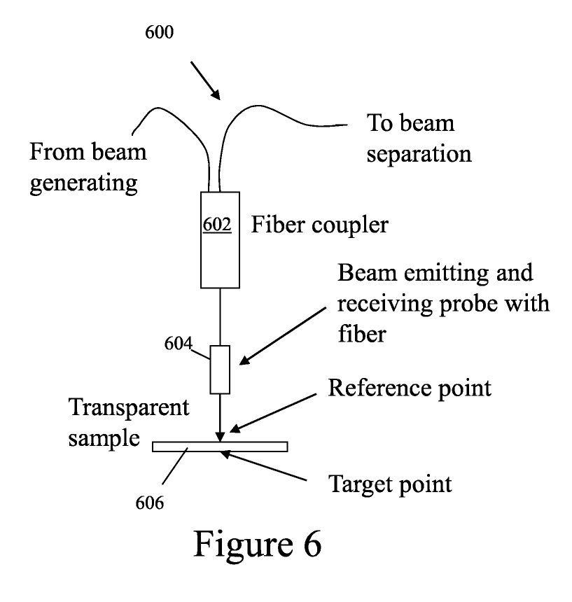

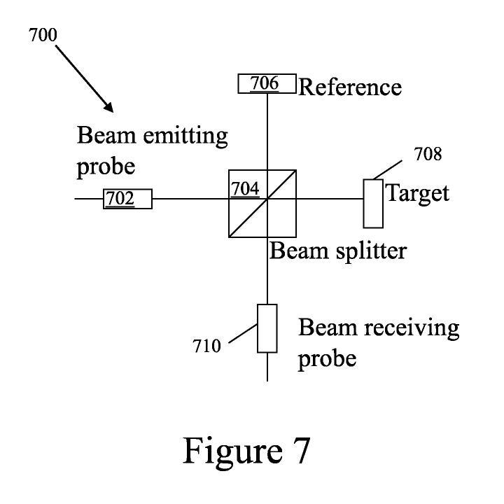

Interferometric beam generating system 504 operate on the test part, extracting metrological data imbedded in an interferometric beam. Exemplary Interferometric beam generating system 504 are depicted in FIGS. 6 and 7.

Interferometric beam separating device 506 receives an interferometric beam from Interferometric beam generating system 504. Beam separating device 506 functions to convert the received interferometric beam to a group of constituent beams, or an interferometric intensity grouping, based on frequency (Interferogram).

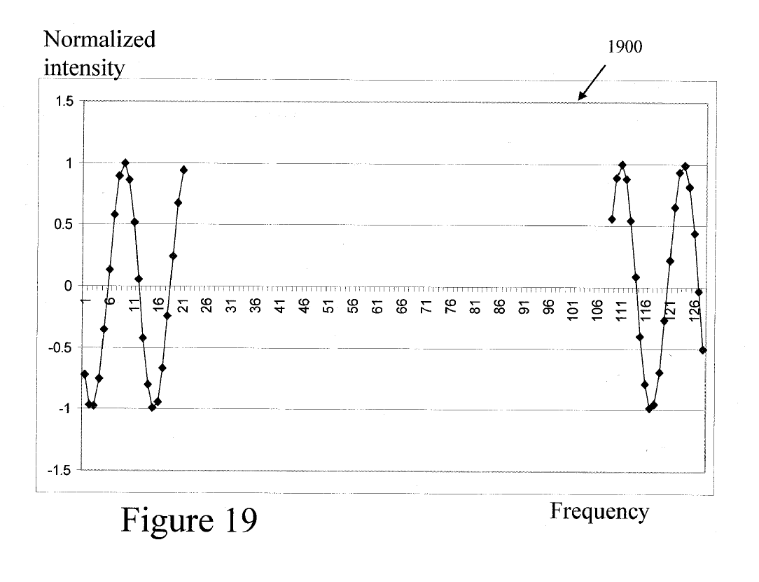

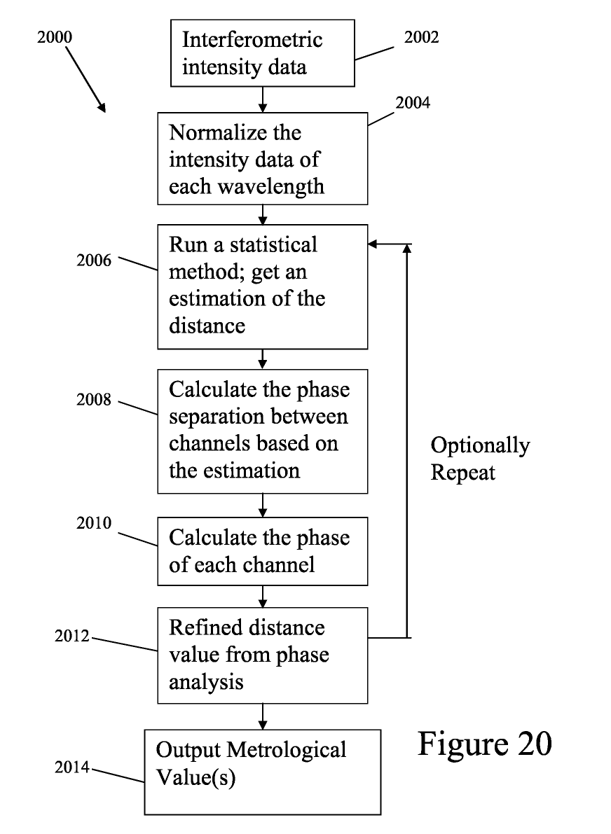

The group of constituent beams, or interferometric intensity grouping is then processed by data acquisition system 508, wherein the system provides a means for detecting, measuring, storing, and analyzing Interferogram data as depicted in FIGS. 19 and 20.

Referring to FIG. 6, the figure depicts interferometer system 600, illustrating an exemplary setup for analyzing a transparent test part 606 using measurement probe 604. Fiber optic coupler 602 guides a composite laser beam into measurement probe 604. Measurement probe 604 also manages the returning interferometric beam, sending it to a beam separation device.

Measurement probe 604 directs a composite laser beam to transparent test part 606 wherein a portion is focused on a reference point or spot located on the upper surface (reference surface) of transparent test part 606, thereby creating a reflected reference point beam. Another portion composite laser beam is focused on a test point located on the lower surface or test surface of transparent test part 606, wherein a reflected test point beam is created. The reflected test point beam and reflected reference point beam interfere with each other creating an interferometric beam that is received by measurement probe 604.

Referring to FIG. 7, the figure depicts interferometer system 700, illustrating another exemplary setup for analyzing a test part 708 using beam splitter 704. Emitting probe 702 transfers the composite beam from the fiber optic delivery system into parallel into a free space focused beam. Beam splitter 704 is a wideband beam splitter type whose T/R ratio is substantially constant in the frequency range of the plurality of constituent coherent laser beams comprising the coherent composite laser beam.

Beam splitter 704 divides and directs a portion of the coherent composite laser beam to a reference surface 706, producing a reflected reference point beam; and the remaining portion is directed to test part 708, producing a reflected test point beam. The reflected reference point beam and a reflected test point beam interact to form an interferometric beam that is received by receiving probe 710.

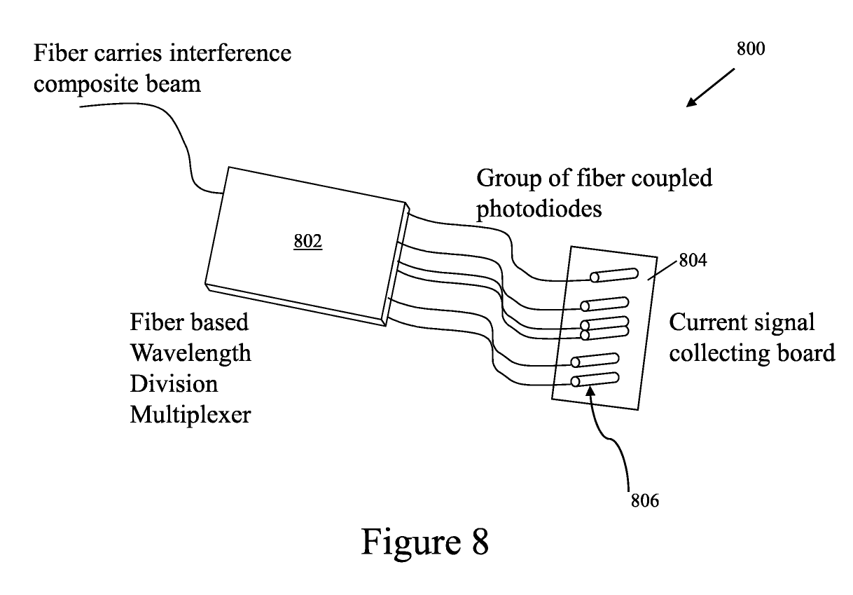

Referring to FIG. 8, the figure depicts a system 800 for deconvoluting an interferometric beam. System 800 depicts an exemplary setup for deconvoluting an interferometric beam into a plurality of constituent beams based on frequency using a wavelength division multiplexer 802 (e.g. CWDM, or DWDM), followed by fiber-coupled array of photodiodes 806 for detecting a plurality of intensity measurements extracted from the produced group of constituent beams based on frequency.

Wavelength division multiplexer 802 a passive fiber based Wavelength Division Multiplexer that is fiber-optically connected to array of photodiodes 806, and separates the interferometric beam into individual channels based on their wavelength. Each of the separated beams follows one of the output fibers and connects to a predetermined photodiode comprising array of photodiodes 806. Constituent photodiode devices comprising array of photodiodes 806 are integrated onto current signal collecting board item 804.

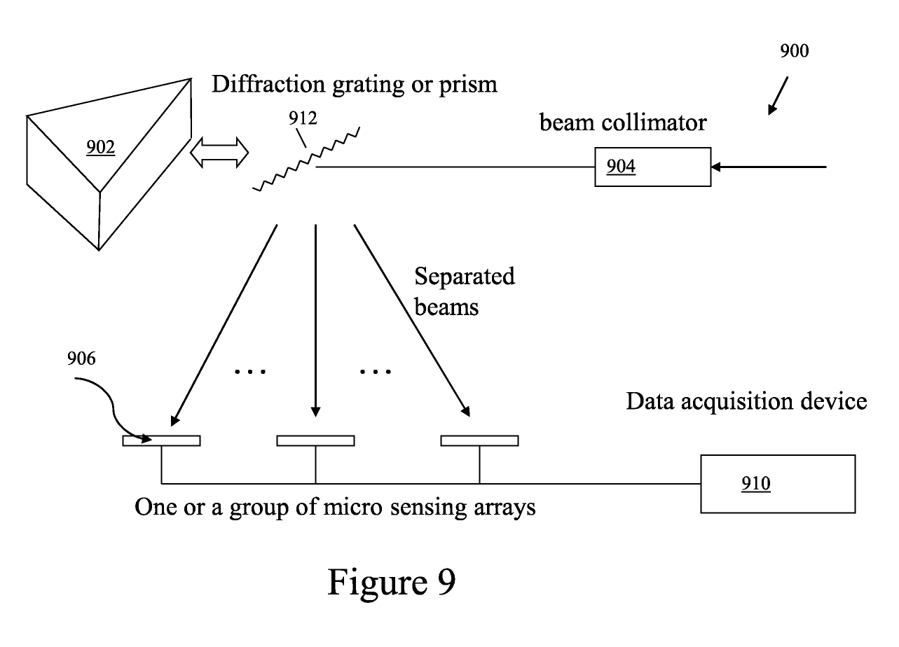

Referring to FIG. 9, the figure depicts another exemplary interferometer system setup for deconvoluting an interferometric beam 900.

System 900 depicts an exemplary setup for deconvoluting an interferometric beam into a plurality of constituent beams based on frequency using either a diffraction prism 902 or diffraction grating 903. The output of diffraction prism 902 or diffraction grating 903 is guided to photo-diode sensing array 906 via an optical fiber-coupled network. Beam collimator 904 provides beam focus to photo-diode sensing array 906. Photo-diode sensing array 906 can be fabricated from a CCD array, CMOS array or the like. A plurality of arrays can be used in situations where several sub-groups comprise the coherent composite laser beam.

Photo-diode sensing array 906 detects a plurality of intensity measurements extracted from the produced interferometric intensity grouping based on frequency. The intensity measurements are delivered to data acquisition system 910, via a signal network connection for analyzing interferogram data.

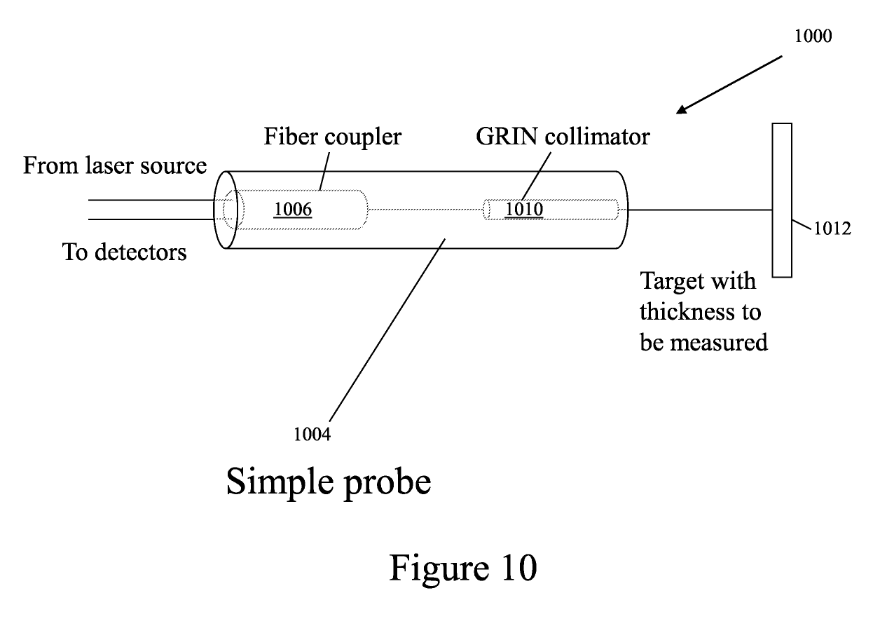

Referring to FIG. 10, the figure depicts interferometer system 1000, illustrating an exemplary setup for analyzing a test part 1012 using simple or compact probe 1004. Simple or compact probe 1004 is comprised of a fiber coupler 1006, followed by fiber ferrule 1008 and a GRIN collimating lens 1010

Fiber coupler 1006 can reside either inside or outside probe 1004. Probe 1004 provides mechanical support for fiber connected ferrule 1008 as well as GRIN collimating lens 1010. Interferometer system 1000 is setup to measure the thickness of transparent test part 1012 (in similar fashion to system depicted in FIG. 6).

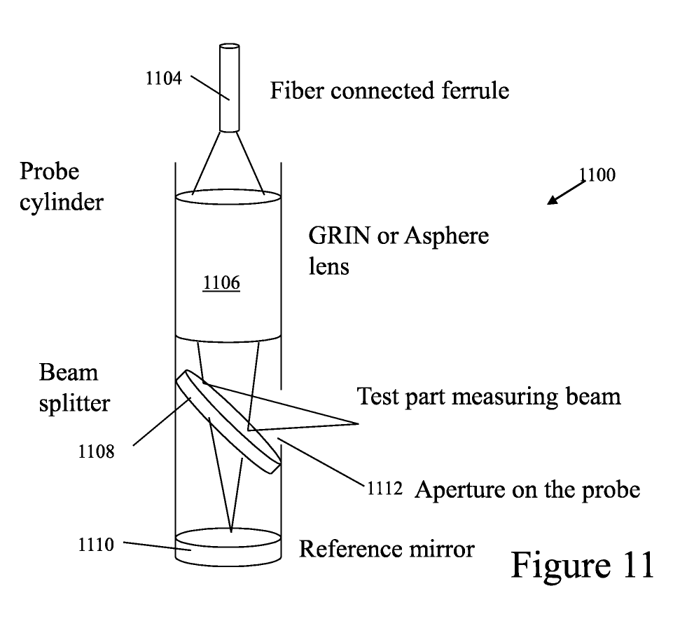

Referring to FIG. 11, the figure depicts a simple probe 1100 (alternate embodiment). Simple probe (alternate embodiment) 1100 is comprised of a fiber connected ferrule 1104, followed by a GRIN collimating lens 1106, or asphere lens, beam splitter 1108, and reference surface 1110. Aperture 1112 is provided to enable a test beam to engage a test part (not shown).

Probe 1100 provides mechanical support for fiber connected ferrule 1104, GRIN collimating lens 1006 or asphere lens, built-in beam splitter 1108, and reference surface 1110.

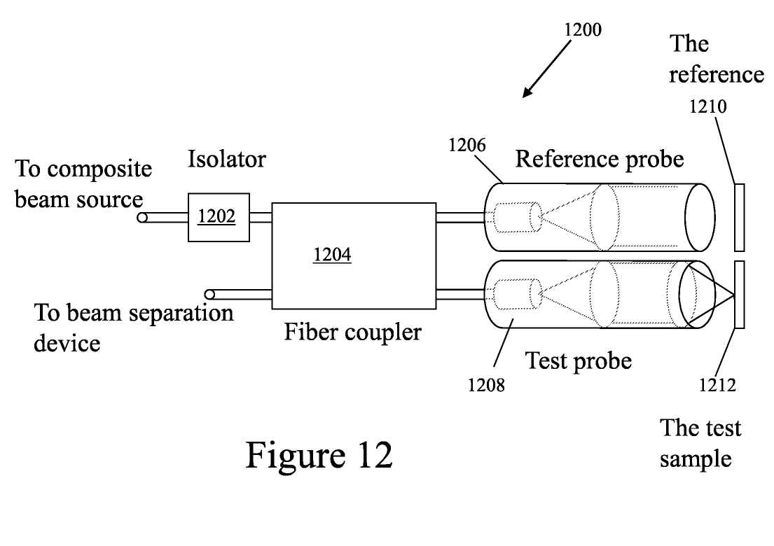

Referring to FIG. 12, the figure depicts exemplary interferometer system 1200, illustrating a configuration for analyzing a test part 1212 surface. System 1200 includes a 2×2 single-mode fiber coupler 1204 that functions as a beam splitter for test probe 1208 and reference probe 1206.

One end of 2×2 single-mode fiber coupler 1204 connects to both reference probe 1206 and test probe 1208; at the opposing end, a fiber optic network provides a link to an optional wideband isolator 1202, configured to accept a coherent composite laser beam. The opposing end of fiber coupler 1204 additionally feeds the produced interferometric beam to the beam separation device or system.

Reference probe 1206 and test probe 1208 can have similar structures, wherein the focal length of each probe can be optionally equal; additionally, more than one lens can be utilized. The distance between reference mirror 1210 and reference probe 1206 can be adjustable, as can the distance between test probe 1208 and test part 1212.

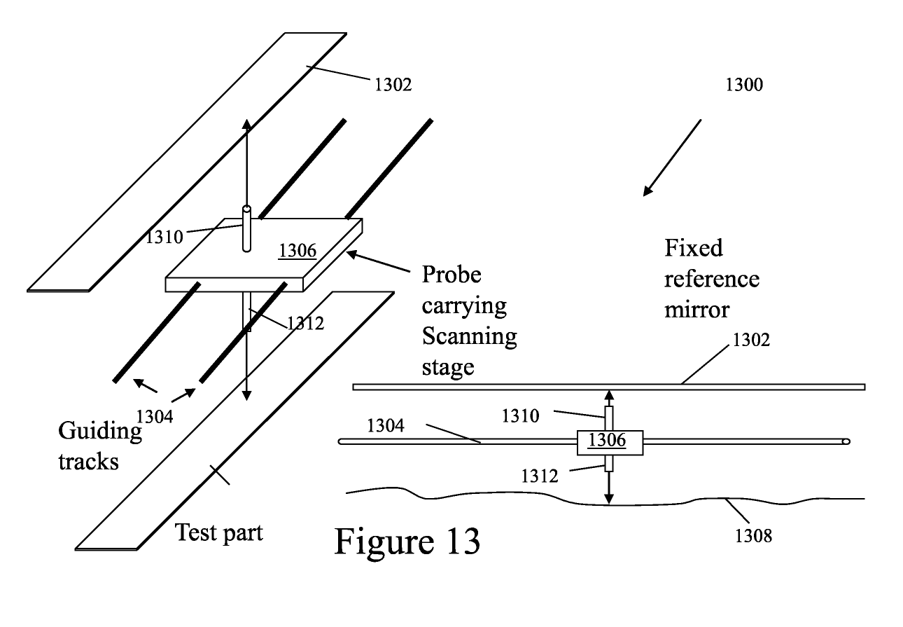

Referring to FIG. 13, the configuration diagram depicts an exemplary one dimensional scanning apparatus 1300 for analyzing test part 1308. One dimensional scanning apparatus 1300 includes probe carrier 1306 for simultaneously supporting both reference probe 1301 and test probe 1312.

It is desirable that reference object 1302 is securely mounted such that oscillations and the like are minimized. Probe carrier driving/guiding apparatus 1304 manipulates probe carrier 1306 thereby providing desired test part 1308 analysis. During operation, the beam from reference probe 1301 determines the stage moving error relative to reference object 1302 while test probe 1312 operates to determine the distance to test part 1308; the distance to test part 1308 is determined with the error correction benefits provided by moving error relative to reference object 1302 factored in.

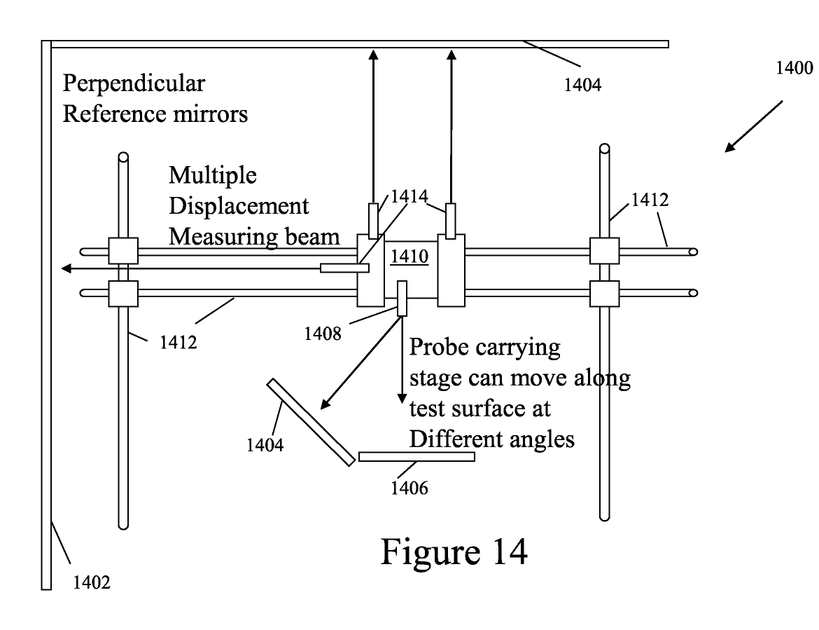

Referring to FIG. 14, the configuration diagram depicts an exemplary two dimensional scanning apparatus 1400 having multiple reference probes 1414 for analyzing test part 1405 and/or test part 1406. Two dimensional scanning apparatus 1400 includes probe carrier 1410 for simultaneously supporting multiple reference probes 1414.

The configuration includes first reference mirror 1402 and second reference mirror 1404 that are perpendicular to each other. In this embodiment, one of multiple reference probes 1414 provides a beam directed to first reference mirror 1402, while the remaining two probes 1414 provide beams directed to second reference mirror 1404.

Probe carrier driving/guiding apparatus 1412 provides two dimensional manipulation of probe carrier 1410. Probe carrier 1410 provides a secure mounting structure for test probe 1408 and multiple reference probes 1414. Test probe 1408 is configured such that generated test beam is capable of analyzing test part 1405 in flat orientation as well as a test part 1406 in angled orientation.

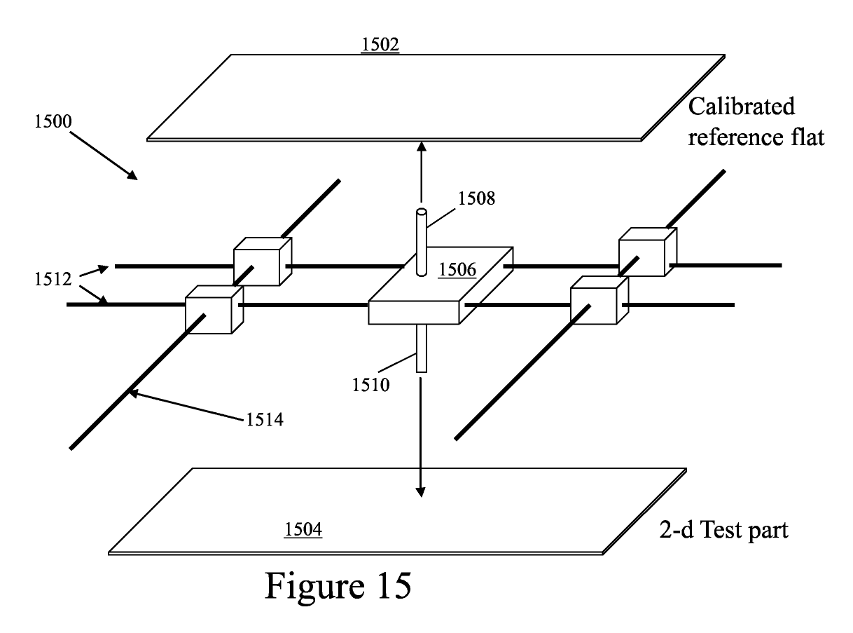

Referring to FIG. 15, the configuration diagram depicts an exemplary two dimensional scanning apparatus 1500 having test probe 1508 and reference probe 1510 mounted on probe carrier 1506. Test probe 1508 is directed to planar or two dimensional test part 1504 while reference probe 1510 focuses on planar calibrated reference mirror 1502.

Probe carrier 1506 is linked to probe carrier driving/guiding apparatus 1512—which controls X-axis movement, and to probe carrier driving/guiding apparatus 1514—which controls Y-axis movement.

In the scanning process, test probe 1508 sends a beam to two dimensional test part 1504 to analyze test part surface while reference probe 1510 focuses on planar calibrated reference mirror 1502 to measure scanning movement error.

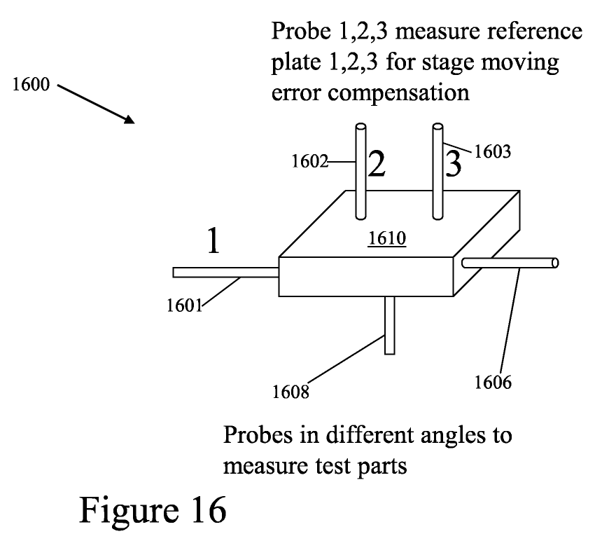

Referring to FIG. 16, the configuration diagram depicts an exemplary probe carrier embodiment 1600, having a probe carrier 1604 supporting three reference probes 1602, 1603, 1604; and two test probes 1606, and 1608. Reference probes 1602, 1603, and 1604, are mounted at different angles to the test part and are utilized in stage-moving-error-correction calculations to provide more accurate measurements. Exemplary probe carrier embodiment 1600 depicts probe carrier 1410 details of scanning apparatus 1400.

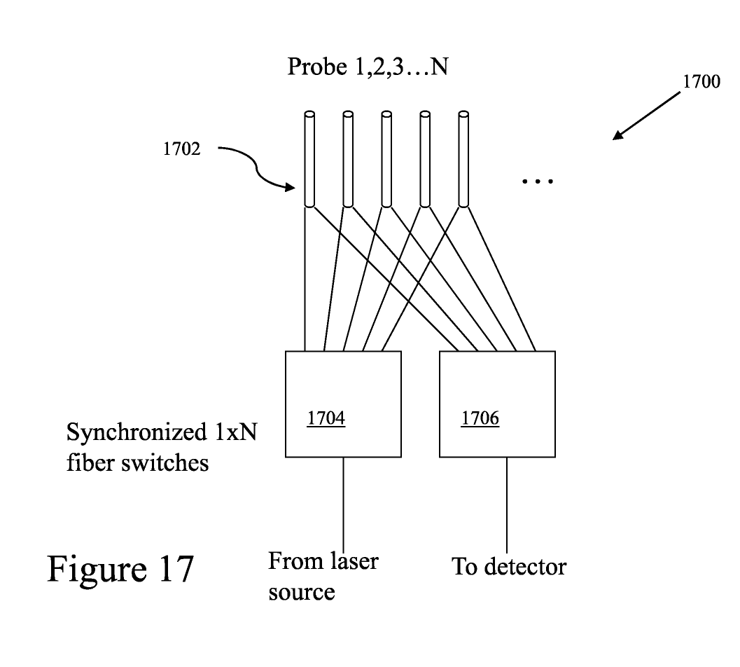

Referring to FIG. 17, the configuration diagram depicts an exemplary high speed switch beam management system 1700 using laser source high speed switch 1704. The probe carrier embodiment 1600 of FIG. 16 can be adapted to such a configuration.

Depicted is a setup for delivering a portion of a coherent composite laser beam to array of probes 1702 and forwarding the resultant group of constituent beams to a detector high speed switch 1706 detecting means by the utilization of a high speed switch.

The beams from array of probes 1702 can come from a single source and be split in a time division manner by laser source high speed switch 1704. A synchronized detector high speed switch 1706 functions to join the returning laser signal in a reversed time synchronized manner.

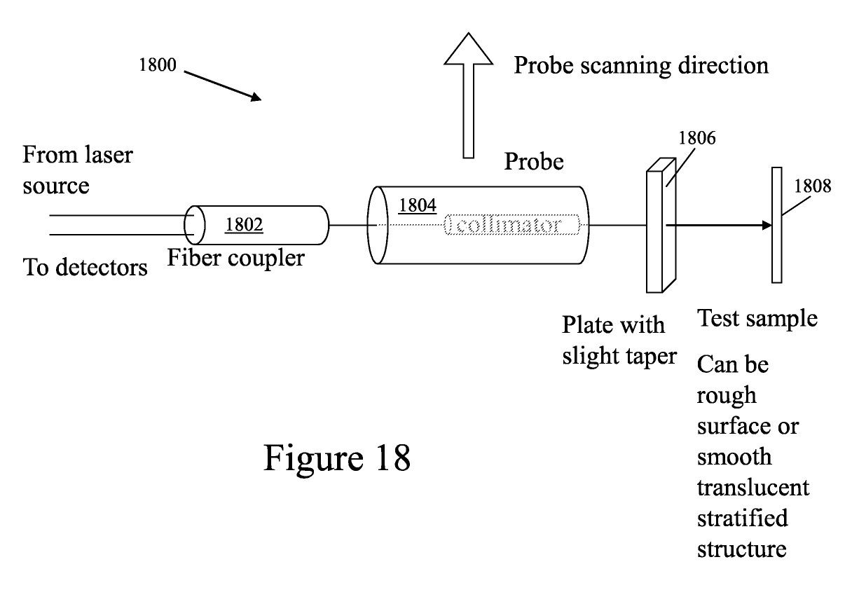

Referring to FIG. 18, the configuration diagram depicts an exemplary instantaneous, phase measuring interferometer 1800 for analyzing a test part 1808. Fiber coupler 1802 provides a fiber optic transmission network for receiving an incoming coherent composite laser beam, as well as directing a produced interferometric beam to a detector system. Interferometer 1800 uses a simple (compact) probe configuration; and a tapered transparent reference plate 1806 positioned between the probe's collimator 1804 and the test part 1808. The present configuration is useful when attempting to analyze a test part 1808 having multiple surface layers. Collimator 1804 portion of probe will guided through the scanning motion during the measurement.

Tapered transparent reference plate 1806 is slightly tapered wherein the thickness variation (taper) varies in the direction of beam scanning. For every given unit distance “L” the probe scans, the change in thickness “T” should be in the proximity of the wavelengths contained in the coherent composite laser beam. The unit distance “L” can be determined by the physical characteristics scale of test part 1808 wherein the measured attribute remains substantially unchanged. For example, unit distance “L” can be 1 or 2 millimeters.

Referring to FIG. 19, the graph depicts exemplary intensity results of a group of constituent beams, where normalized intensity is plotted with respect to frequency. Graphs, such as the example in FIG. 19, and the like, can be generated using well know statistical techniques. The apparatus and methods to generate the raw intensity data with respect to frequency are depicted in exemplary FIGS. 8 and 9.

Referring to FIG. 20, the figure depicts an exemplary flowchart 2000, illustrating an exemplary method for phase calculation leading to a metrological measurement or value. The following description is directed to a nonlinear iteration method directed to interferometry-related systems, although the teaching is equally applicable to situations where high accuracy phase and frequency analysis is required.

### Sampling Points Data Structure

Suppose an interferometer has a group of laser beams with frequency:

fᵢ=f₀+iΔf Eq15

Or it may have several groups of beams with frequency:

$${f}_{i}^{1} = {f}_{0}^{1} + i Δ f … {f}_{i}^{n} = {f}_{0}^{n} + i Δ f \qquad Eq 16$$

Where, i is from 1 to N.
Usually, the frequency difference between groups are large enough so that:

(f₁^{k}−f_{N}^{k-1})>>Δf Eq17

FIG. 1 shows an example where there are three groups and each group has 24 beams.

The power of each beam may vary. And it is highly suggested that all the sensors go through a modulation calibration process, which will modify the gain for each sensor. After the calibration, all the channels' gain and offset should have the same response function to the reflectivity of the test point. But each channel may have its independent random noise.

The outcome intensity is several segments of sinusoid data:

Iᵢ^{k}=A+B cos(2πDfᵢ^{k}/c) Eq18

Where A and B are constants, and D is the light path difference. The phase φᵢ^{k} is 2πDfᵢ^{k}/c where c is the speed of light.

We know D is a function of both φᵢ^{k} and Δφ. We define the phase difference between beams as:

Δφ=φᵢ^{k}−φᵢ₋₁^{k} Eq19

Then D (the light path difference), φᵢ^{k}, Δφ, fᵢ^{k}, Δf and Iᵢ^{k} are connected by several linear functions and one non-linear sinusoid function.

Now the mathematical problem is to find an iteration method that can determine φᵢ^{k}, Δφ and D.

Presented is a new and novel method that quickly converges on a substantially accurate solution. Additionally, the method is highly robust, wherein it can handle random noise and systematic error from the interferometric system. It contains several steps and each step may have several procedures that can deal with different Δφ ranges.

Before the iteration steps, the interferometric intensity data 2002 need to be preprocessed.

By scanning over a intensity calibration section, a intensity normalization process 2004 can be performed.

### Steps of Iteration Process

### The Following is a List of the Steps in the Method

Step 1: obtain an estimate of Δφ.

Step 2: by knowing Δφ, one can use the value of Iᵢ^{k} and its neighbor beams' interfered intensity to calculate the value of φᵢ^{k}. This step corresponds to process steps 2006 and 2008 of FIG. 20.

Step 3: unwrap φᵢ^{k}, this step corresponds to process step 2010 of FIG. 20

Step 4: line up unwrapped φᵢ^{k} with fᵢ^{k} and run a Least Squares Fit to find the slope of (Δφ/Δf)ₖ.

Step 5: use (Δφ/Δf)ₖ to adjust the unwrapped φ^{k} by adding 2πlₖ, where Iₖ is an integer.

Step 6: line up unwrapped φᵢ¹ through φᵢⁿ with fᵢ¹ through fᵢⁿ and run an overall Least Squares Fit to find the slope of (Δφ/Δf)_{1→n}.

Note that above steps 3 through 6 align with process step 2012 depicted in FIG. 20.

The result of step 6 should give a very accurate value of Δφ. Additional accuracy for Δφ is possible by repeating the process from step 1, repeating the process until the desired accuracy is attained.

### Detailed Discussion of Individual Steps Include:

First Step: estimate Δφ

In step one, we need to estimate an initial value of Δφ. Since there are limitations of the Fourier analysis method, we use the neighbor signals sinusoid data structure to solve the problem.

For a interfered intensity Iᵢ, the phase differences of its left and right neighbors are:

Iᵢ₋₁=A cos(φ−Δφ)+O=A(cos φ cos Δφ−sin Δφ)+O

Iᵢ=A cos φ+O

Iᵢ₊₁=A cos(φ+Δφ)+O=A(cos φ cos Δφ+sin φ sin Δφ)+O Eq30.1-30.3

We can construct two neighboring functions:

$$\begin{matrix}{I}_{i}^{c} = \frac{{I}_{i + 1} + {I}_{i - 1}}{2} = A cos {φ}_{i} cos Δ φ + O & Eq 31.1 \\ {I}_{i}^{r} = \frac{{I}_{i + 1} + {I}_{i - 1} - 2 {I}_{i}}{2} = A cos {φ}_{i} ( cos Δ φ - 1 ) & Eq 31.2\end{matrix}$$

If the standard deviations of noise in I, I′ and I^{c} are σ, σ^{r} and σ^{c} the signal to noise ratios of I, I^{r} and I^{c} can be shown as

$$\frac{A}{σ} \\ {sn}_{1} = \frac{A cos Δ φ}{{σ}^{c}} \\ {sn}_{2} = \frac{A ( cos Δ φ - 1 )}{{σ}^{r}} \qquad Eq 32$$

When Δφ is close to 0 or π, sn₂ is very small. Therefore we run a Least Squares Fit:

Iᵢ^{c}=β₁Iᵢ+α₁ Eq33

And it is easy to get:

Δφ=arccos(β₁) Eq34

When Δφ is close to

$$\frac{π}{2} or \frac{3 π}{2} ,$$

sn₁ is very small. Therefore, we run a Least Squares Fit:

Iᵢ^{r}=β₂Iᵢ+α₂ Eq 35

Since I^{r} is the second order derivative of I, β₂ should be negative. And it is easy to get:

Δφ=arccos(β₂+1) Eq36

Second step: calculate φᵢ

The easiest way to solve the functions of Eq30.1, Eq30.2 and Eq30.3 is to eliminate the A and O:

$${I}_{i + 1} - {I}_{i - 1} = 2 A sin φ sin Δ φ \\ {I}_{i + 1} + {I}_{i - 1} - 2 {I}_{i} = 2 A cos φ ( cos Δ φ - 1 ) \\ {φ}_{i} = arctan 2 ( \frac{{I}_{i + 1} - {I}_{i - 1}}{sin Δ φ} , \frac{{I}_{i + 1} + {I}_{i - 1} - 2 {I}_{i}}{cos Δ φ - 1} ) \qquad Eq 37.1 \text{-} Eq 37.3$$

Eq37.1 and 37.2 are equivalent to the first and second order of derivatives of the Iᵢ with the frequency coefficient adjusted by the discrete sampling space. Eq37.3 does not have A and O so that it is not affected by the gain and offset error.

Unfortunately, Eq37.3 is not always applicable. When Δφ is close to π, Iᵢ₊₁−Iᵢ₋₁ and sin Δφ are both close to zero. That makes Eq37.3 a sick equation dominated by the noises. But the second term has good signal amplitude. We can use an alternative formula to determine φᵢ.

We can rewrite Eq31.2 as the following:

$${I}_{i}^{r} = \frac{{I}_{i + 1} + {I}_{i - 1} - 2 {I}_{i}}{2} = {A}^{p} cos {φ}_{i} \qquad Eq 38$$

Since Δφ is close to π, most likely, Iᵢ^{r} and Iᵢ₊₁^{r} have different signs. Suppose Iᵢ^{r}<0 and Iᵢ₊₁^{r}<0, we know there is a point between φᵢ and φᵢ₊₁ must have the value of

$$\frac{π}{2} .$$

Let φᵢ+φ=π/2, we should have the following equations:

$${φ}_{i} = \frac{π}{2} - ϕ \\ {φ}_{i + 1} = \frac{π}{2} - ϕ + Δ φ \qquad Eq 39$$

From Eq38 and Eq39 we have:

$$\frac{sin ϕ}{sin ( ϕ - Δ φ )} = \frac{{I}_{i}^{r}}{{I}_{i + 1}^{r}} \qquad Eq 40$$

Then we can obtain the following:

$${φ}_{i} = \frac{π}{2} - arctan ( \frac{\frac{{I}_{i}^{r}}{{I}_{i + 1}^{r}} sin Δ φ}{1 + \frac{{I}_{i}^{r}}{{I}_{i + 1}^{r}} cos Δ φ} ) \qquad Eq 41$$

It is trivial to get similar equations for the case of

$$\frac{3 π}{2}$$

or using

$$\frac{{I}_{i}^{r}}{{I}_{i - 1}^{r}} .$$

If more than one value is calculated from the front and from the back, an averaged number can be used.

When Δφ is close to zero case, the outcome of Eq37.3 becomes more sensitive to random noise. The terms of Iᵢ₊₁−Iᵢ₋₁, Iᵢ₊₁+Iᵢ₋₁−2Iᵢ, sin Δφ and cos Δφ−1 are all close to zero. Both the first and second derivatives are dominated by the noises. Then we have to evaluate both A and O to calculate φᵢ.

### From Eq33 we can get:

$$O = \frac{{α}_{1}}{1 - {β}_{1}} \qquad Eq 42$$

After O is fitted, we can calculate the following:

$$\begin{matrix}{I}_{i}^{a} = \frac{{I}_{i + 1} + {I}_{i - 1} - 20 }{2 cos Δ φ} = A cos {φ}_{i} & Eq 43 \\ {I}_{i}^{b} = \frac{{I}_{i + 1} - {I}_{i - 1}}{2 sin Δ φ} = A sin {φ}_{i} & Eq 44\end{matrix}$$

Then we can get an averaged A by take the square root of following value:

$$A = \sqrt{\sum \frac{{( {I}_{i}^{a} )}^{2} + {( {I}_{i}^{b} )}^{2}}{N}} \qquad Eq 45$$

We can get by applying cos⁻¹ function to the gain and offset-adjusted intensity data.

If Δφ of the neighboring samples is really small, we can use Δφ^{g}=Σ(φᵢ^{k+1}−φᵢ^{k})/N for the above calculation to obtain A and O. When calculating I^{a} and I^{b}, instead of using the neighbor sampling in the same group, we can use the corresponding intensity from the neighbor group.

### Third Step: Unwrapping the Phase

Inside each group, if φᵢ is adjusted, use φᵢ+Δφ to adjust φᵢ₊₁. It means to find an integer p so that

|φᵢ+Δφ−2pπ−φᵢ₊₁|<π

And the adjusted value for φᵢ₊₁ is φᵢ₊₁+2pπ.

Fourth Step: Run Least Squares Fit (Frequency on Phase) in each Group

Inside group k, the phase data is lined up by the previous step. It should be a linear function of the laser frequency:

φᵢ^{k}=β^{k}fᵢ^{k}+α^{k}

A simple fit can help us get the coefficients.

### Fifth Step: Line Up Phases in Different Groups

Find a group of integers q^{k} so that after adding 2q^{k}π to every phase value of group k, all the segments are in the same line. Each phase value should not be far away from the line.

Sixth Step: Run Least Squares Fit with all the Phase and Frequency Data

φₓ= β̅fₓ+ α̅

Where β̅ is the phase frequency slope and can be associated with Eq12 to determine D. Meanwhile α̅ is the phase at fₓ₌₀ and can be associated with Eq6 to determine D. Combine the two equations, an accurate and long range measurement of D can be obtained.

Calibration parts can be used to test the accuracy of the final fit and to determine the threshold for the residue evaluation. It is the summed phase residue after the segments are lined up in step five. The number of times of iteration is determined by how tight the threshold is. Additional details can be found in provisional application USSN: 61/218,894; (DOCKET NO. 937-LS) which is incorporated by reference, in its entirety, into this disclosure as if fully set forth herein; the sole inventor directed to provisional application USSN: 61/218,894 is Mr. Si Li, the same inventor of the present invention.

### Section 2

### Interference Components

There are multitudes of interferometer configurations that are capable of the functioning in cooperation with the present invention, including the Michelson style, a Mach-Zehnder, a Sagnac style interferometer. Configuration selection will be in part based on the particulars of a given application. The beam splitting devices or systems include open optical, as well as conventional beam splitter types. Both the test and reference beams, can be coupled into optical fibers or can alternately be kept in open optical paths to the reference mirror or measuring probe. The beam splitting parts can also be configured from pure fiber optic type systems. For example, a Michelson splitter can be formed by using a 1×2 or 2×2 optical coupler.

If a fiber, or fiber optic based device is used as the test beam wave-guide instead of an open space path, the wave front may induce a phase shift when traveling from the coupler to the probe. Given a one point measurement, it may not be an issue; however, if the interferometer has to scan over a line or a surface, a constant phase difference between light path of the test probe and the reference mirror is required. A solution is to put the reference beam in exactly the same kind of fiber with the same length and bond it together with the test fiber using materials that allow them to bend together but not move (bent or twist) relative to each other. (A double core fiber may be used for such a purpose.) And there should be no temperature difference at any place between the two fibers. In such a case, the light in the fiber should have the same phase drifting and the phase difference will have negligible drifting.

The use of fiber and coupler can make the interfering parts very compact. The coupler itself can be a part of the measuring probe. In such a case, the test and reference fiber can be very short and can cause almost no phase drifting difference.

Some interferometer configurations can be constructed without any beam splitting parts, may implement non-separated paths (a single beam) for test and reference beams utilizing devices that can temporarily block the reference beam; the configuration shown in FIG. 6 depicts such an example. The fiber coupler 602 in the figure plays no roles in the interference process; it simply sends signals to the detectors. Both reference and test beams (which may be reflected by different surfaces of the test part) will be received by the probe 604 and be coupled into the fiber by the GRIN collimator. This design can be used to measure the depth of the light path between the two reflecting surfaces. If open space optical parts are needed for this purpose, the split beams can be absorbed. If a switch or a blocking device for the reference beams is added, it may work in a very high frequency way, for example, with every other data sampling.

For open space light paths, it is important for reference beams travel paths to match, as closely as possible, with the test beams paths. With the two beams traveling through the same environment, any turbulence will cause the same phase drifting in them. So the measuring probe may include the reference beams reflecting parts in addition to the beams control parts for the test beams. Other configuration examples include embodiments that use half reflective splitter and GRIN lens to build a compact probe. The test and reference beams in the figure can exchange their positions.

### Frequency Structure of Multi-Wavelength Beams

The designed interferometer comes with a laser source component. Different from conventional phase measuring laser source, this component does not have any quarter wavelength shift plate or other phase shifting parts. It does not have two wavelengths that are significantly different (for example 600 nm and 800 nm) to form an extended synthetic wavelength. Instead, it emits one or several groups of beams. In each group, there are many beams separated by a constant frequency difference. The frequency step can be determined by matching a desired measuring range. (For example it can be 12.5 GHz or 50 GHz). The wavelength difference between the groups can be determined by matching the desired resolution power. The difference of wavelength between the first beams in each group can have a typical number of 20 or 30 nm. FIG. 1 shows an example of two groups of beams combined for the measurement.

### Generating Multiple-Wavelength Beams

There are several methods to generate aligned multiple wavelength beams. Beam combining devices such as CDWM and DWDM Multiplexer can be used to join the beams from individual laser diodes together. This method is good for some kind of frequency structure but it may not be the most energy and economically efficient way for other frequency structures. Some manufacturers have developed laser sources with an array of laser emitting units built in a single chip. For example one product has an array of 186 units and each of them can emit a beam that has a 50 GHz frequency difference with its neighbor. Unfortunately, currently the product can only be operated as a tunable laser. To change the product and allow it to emit more beams at a time is not a difficult task. In the near future, an improved product may become commercially available. That will become a perfect light source of the multi-wavelength instantaneous interferometer.

Another way to obtain multi-wavelength beams is to use a non-linear optical modulator to generate a laser comb.

When Lithium Niobate crystal is driven by a sinusoid voltage to be a phase modulator, the number of outcome beams is determined by the frequency of the laser and the frequency of the driving voltage. Lasers with wavelength around 1550 are easy to be driven to generate more beams. However, the spacing of the separation of the beams, which is determined by the driving voltage frequency, has its limits. The larger the spacing, the less number of comb teeth can be generated. Therefore, the total wavelength difference of the last beam and first beam is limited for a single laser beam input.

To overcome random noise and other sources of error, a minimum wavelength difference between the first and the last beam is required. In the example mentioned above, 186 beams with 50 GHz spacing, should sufficiently meet the requirement. However, it is impossible to obtain so many beams with 50 GHz driving voltage. If the driving voltage has a frequency around 10 GHz, it is fairly easy to obtain more than 20 beams for a single incoming laser. But the total wavelength is far from enough. The solution is to use more than one incoming laser. The lasers can be chosen to have the desired frequency difference. Each laser beam will generate a beam group by the modulator. For example, two of such groups can be created. For a noisy working environment, a large total spacing may be needed, wherein a comparison between the first group with the last one contained in the data pattern may be necessary. The further separation, the harder it is to make the connection; the utilization of additional more centrally located groups may be needed to help with the data connection for analysis.

The above mentioned phase modulator offers extreme accurate beam spacing within each group. The spacing between groups is determined by the frequency drifting of the laser diodes. A control system to compensate the frequency drifting and/or intensity drifting can serve to improve stability thereof.

### Laser Generating Accessories

The output of a multitude of lasers can monitor by a tilted cavity having a sensor array. It is equivalent to a group of interferometers with a consistent increasing optical path difference. The resultant measured result produced will have a generally sinusoidal shaped signal. A change in amplitude indicates the intensity drift. The change of phase indicates the laser frequency drift. Optionally, the measured drifting value can be sent to a feedback control system, which can change the current of the laser to adjust the frequency and change the temperature to modify the intensity of the laser output.

An optional laser intensity amplifier can be placed before or after the phase modulator. But in most applications this apparatus may not be necessary. Additionally, polarization control component may also be positioned at the same locations.

FIG. 3 shows a simple example of the laser source module. The intensity variations of each laser source are recorded for numerical compensation. A heat sink is used to stabilize the temperature and served as frequency drifting controller. TEC on the heat sink may or may not be needed depend on the requirement of frequency stability.

### Avoidance of Complex Imaging System

Since so many beams are involved, even though aligning all beams together is not a challenge with the help of fiber technology, it is almost impossible to build so many imaging systems to measure a two-dimensional interference pattern. Therefore, the interferometer will measure a single point at a time. With the simplicity of the imaging system, the interference of every beam can be measured all together at the same time. This will eliminate the effects of mechanical oscillation and optical and electronic drifting for a single point measurement. These effects still have influences when measuring different points at different times, but they can be compensated relatively easily (details later in the section on “One-dimensional profiler as an embodiment”).

### Separating Multiple-Wavelength Beams

After the test beams and reference beams rejoin at the beam splitter or in the fiber coupler, there must be a device to separate every beam based on their wavelength. There are more than one method to achieve this. Depending on the spacing of the wavelength difference, the number of the groups and the total number of beams, the most convenient and the most economical choice may differ.

One way is to use a commercially available WDM DeMux or a wavelength filter followed by a group of WDM DeMux to perform the separation. This will make the device very compact in space and reduce the engineer cost to build it. But the parts may be very expensive and are only available for larger spacing (close to 50 GHz). For beams with spacing close to 10 GHz, currently it is difficult to find commercially available DWDM. However, coarse wavelength filter-based CWDM DeMux is inexpensive. For light source with laser beams separated by 20 nm wavelength spacing, it is practical to use such a device.

A different approach is building a self-stand open space DWDM. A prism or a grating can be used to diffract the beams and direct them into an array of sensor diodes. If the space is limited and one level of grating is not powerful enough, multiple-level grating can be used. The major cost of this method comes from the engineering cost of aligning the sensor array against the incoming beams and the diffraction parts.

Another approach is to use a beam splitter to split the beams into many branches and place an extremely narrow band path filter before the sensor. The tiny filter plate can be tilted to the desired angle to allow the next beam to pass. The shortcoming of this method is the significant loss of power if the total number of beams is large. Furthermore, aligning the filter plate to a particular angle add a lot of engineering cost.

Additional polarization control parts may be placed in front of the sensors before the beams reach the sensors.

If the separation parts and the sensors are compact enough, the whole interferometer can be carried by the moving stage. If an open space method is used, it would be too bulky to be carried. In such a case, the moving stage can carry only the measuring probe and fibers are needed to connect the beam splitting device and the probe. This laser-guiding device should also include the parts that prevent over-bending of the fibers.

The sensors array should be put in the places where each separated single-wavelength beam can reach one sensor (for high resolution CCD or CMOS array, each beam can reach a group of sensing units). The interfered beam intensity then should be converted into electronic signal by the sensors.

### Data Collection and Analysis

A computer-controlled data acquisition device is connected to the sensors. Besides data collection controlling, the computer should also control the scanning movement and should monitor the laser sources for compensation.

Each reference beam with a particular wavelength should interferer with the test beam with exactly the same wavelength. The sequenced intensity measurement of separated interfered beams in different wavelengths would show a sinusoid. If the spacing of the wavelength difference is a constant, the phase difference of each sampled point in the measurement should also be a constant. The phase difference is a function of the distance between the test part and reference mirror. We call this function the “Distance to Phase Difference function” or “DPD function.” The phase at each sampled point is also a function of the same distance. We call this “Distance to Phase function” the “Dfunction.” Both functions have a measuring range limit of two-PI. However, the two-PIs correspond to different distances. The DP's two-PI is determined by the wavelength. The DPD's two-PI is determined by the spacing of the wavelengths. The DPD have a significant larger measuring range compared to the range of DP, which is usually sub-micrometer. For example, if the spacing is 50 GHz, the DPD should have a range of 3 mm and 15 mm for 10 GHz spacing. The two groups of beams interference results are shown in FIG. 19. We can see two segments of the periodic patterns. The range of the variation of each segment is from zero to the Nyquist limit. To reduce the error of the DPD function, it is very important to combine the two segments of signal together and align them to form a united DPD function.

The DP function has been shown to be robust to different error sources in various industrial environments and low contrast of the fringe pattern if a proper data processing procedure is chosen. But the data processing procedure of DPD function needs to be more robust to error sources because of the large measuring range. And it needs more sampling points to overcome the random noise. Since the data collection speed and capacity have increased significantly in past years, we can afford to have many sampling channels to reduce the effects of noise. And when we can reduce the error of the DPD function to less than half of the DP function's measuring range, we can combine the two functions to have a new function that have DPD function's measuring range and DP function's accuracy. Furthermore, the large number of channels increases the accuracy not only for the DPD function but also for the DP function. The final accuracy and robustness of the DP with a large number of channels should be much better than the conventional phase shifting interferometer.

For non-even spacing beams shown in FIG. 1, the measured intensity pattern is shown in FIG. 19. The Phase Difference is no longer a constant. The above-mentioned DPD function can be replaced by the slope of the fitted phases relative to their frequency. This slope has all the properties of DPD function and can be treated similarly.

### Probe Carrying and Scanning Components

The above discussion has covered the major components in FIG. 5, which include: multiple—beam generating, interference generating, and beam separation parts. Additional apparatus are needed to make different embodiments for various applications.

Without moving the measuring probe, the device can measure a single point at a time. The probe can move in many different ways to measure different targets. For example, it can be carried to move along a straight line with 1 or 2 degrees of freedom. Or it can move along a piece of arc. It can also scan over a two-dimensional flat surface. Or it can even scan over a section of a sphere.

The simplest probe carrier can move along a line with one degree of freedom. The designed structure is to restrict twisting so that the outgoing beams keep parallel to one another. Since the error caused by a deviation from the parallel position is a cosine error, the restriction of severe twisting will make the error negligible. However, mechanical oscillations along the beams' outgoing direction will be significant. This oscillation must be compensated, which can be achieved by using a second motion detecting interferometer (see below).

### One-Dimensional Profiler as an Embodiment

An inexpensive displacement measuring interferometer can solve the above oscillation problem. The measuring beam of such an interferometer can move in the opposite direction of the main laser beams. It will hit a band-shaped reference mirror with perfect reflection and calibrated height-position profile. The mirror should be fixed in a place separate from the probe driving and test part loading components and should not oscillate while the probe-carrying device is moving. By combining the two interferometers' results together, the error caused by the scanning movement will be removed.

One embodiment of such a scanning device can be a non-contact profiler. Compared to a stylus based profiler it can scan much faster and can measure much more delicate surfaces. It will also have a larger measuring range of step-size. As long as the local roughness does not totally destroy the surface reflectivity, it can be measured in any range. From the measurement data, not only the form features of the parts can be extracted, but also information on local roughness. FIG. 13 shows the basic structure of this embodiment.

For a cylinder with its axis loaded to a rotational axis, if the probe scanning trace is parallel to the spindle and the measuring beams go perpendicular to the spindle, with nicely focused beams the device can measure any form feature of the cylinder including its diameter.

### More Complex Profiler as an Embodiment

To measure a cone surface, the scanning trace should move along the cone surface and the beams should be perpendicular to the cone surface.

The probe moving trace should always be perpendicular to the beams' out-going direction. Only one motion error reference mirror is needed if it is parallel to the test part. Sometimes it is not easy to set up the measurement because it is hard to set a reference mirror that is always parallel to the test surface. For example, if a rotational symmetric part has both a cone surface section and a cylinder surface section, to measure both the probe needs to have the ability to emit measuring beams in multiple directions. That requires the scanning device to have two degrees of freedom in movement and the probe can move along a line in different angles. A fixed motion error reference mirror can measure the motion error in one direction and changing the mirror direction is not feasible. Therefore, two displacement reference mirrors perpendicular to each other should be used. With more than one displacement interferometer, the moving error in the two perpendicular directions can be combined to indicate the movement error along the measuring beams' out-going direction at anytime.

An embodiment of such multiple movement error compensation channels can measure the relative form features between surfaces of a test part. The basic structure of the design is shown in FIG. 14.

The displacement interferometers can be saved if we can use the primary multiple wavelength interferometer in a time dividing way. The optical fiber switches can be used to send the beams to several probes in a controlled sequence. Some of the probes can be used as movement error measuring probe, others can be used as parts measuring probe. If the speed of the switch is high enough (higher than the stage oscillating rate), the interfered position should be accurate enough for the moving error compensation. FIGS. 16 and 17 shows the concept of this method.

### Two Dimensional Profiler as an Embodiment

The probe can also scan along a two-dimensional plane that is perpendicular to the measuring beams and parallel to the test surface. In such a case, a two-dimensional reference mirror with perfect reflection and a well calibrated two-dimensional position-height profile and a displacement interferometer will help correct the motion error and define an embodiment that can measure a two-dimension flat region. This embodiment is ideal for inspecting computer chips with fine steps and complex structures and delicate flat surface. See FIG. 15 for an illustration of the basic structure.

Embodiments that Measure Spherical Surfaces

The spherical surfaces of optical parts usually need careful inspection. The above interferometer can be carried on a scanning device moving along a piece of arc to form an embodiment that can measure spherical surfaces with different surface curvature. The lens can be loaded to a rotational axis with its optical axis right on it.

The concave spherical measurement probe should have a pivot. A reference mirror band, which can be a thin section of cylinder ring, goes along with the pivot. The pivot axis should be right on the cylinder axis. As the probe turns around the pivot, the distance measurement beams can measure the profile of the concave sphere. However, the probe will oscillate and there would be a radial movement error. The error can be determined at any time by a displacement measuring laser beam from the other end of the probe going toward the reference mirror. The distance measuring beams will scan over a plane when the probe is turning. The rotation axis should be in this plane and the axis should pass the pivot. Furthermore, to measure lenses with different surface curvature, the distance between the rotation bearing and the probe turning pivot should be adjustable so that the spherical center of the surface is on the pivot.

To measure a convex spherical surface, a slightly different probe moving mechanism is needed. The reference mirror should also be a section of a very short cylinder but has a much larger radius compared to the one used for concave lens measurement. The radius should also be larger than that of the test lens surface, and the cylinder axis of the reference mirror and the center of the spherical surface should be loaded at the same place. Between the reference and the test surfaces there should be room for the guiding tracks that the probe can scan along. The guiding tracks can be two rings that have the same axis as the reference cylinder section. When the probe is scanning along the tracks, the distance measuring beams always come out the probe and go towards the center of the spherical surface while the displacement-measuring beam goes towards the reference mirror. The test part should again be loaded on a rotation axis that is in the measuring beams scanning plane and just passes the optical center.

### Lens Center, Film or Plate Thickness Measuring Embodiment

When the probe is measuring a lens surface region that is very close to the rotation axis, the reflected beams from the opposite surface will also come back to the probe. The interference between the reflected beams of two opposite surfaces of the lens can be used to determine the center thickness of the lens. At the same time, the reference branch of beams of the distance-measuring laser may or may not be blocked with different data processing algorithm.

The thickness of a media with two parallel surfaces can be measured in the same manner. For example the thickness of a film or a wafer plate can be measured with this method. If the surface feature is not needed but the thickness information is, neither the reference beams of the distance-measuring laser nor the motion error-monitoring device are needed. The probe and the test parts can simply scan each other by keeping the two reflecting surfaces perpendicular to the beams.

What is claimed herein is:

1. An instantaneous, phase measuring interferometer for metrological analysis, comprising:
a means for generating a coherent composite laser beam, comprised of a means for generating a test laser group, wherein said test laser group is configured from a plurality of simultaneously active coherent laser beams each having a substantially constant intensity output and a unique operating frequency, and
said plurality of simultaneously active coherent laser beams having a crescendo of said unique operating frequencies such that each said unique operating frequency comprises a frequency differential increment, determined by the frequency difference between said unique operating frequency and the consecutively higher said unique operating frequency thereby creating a plurality of frequency differential increments,
at least one said frequency differential increment differs in magnitude from remaining said plurality of frequency differential increments; and
a means for combining said plurality of simultaneously active coherent laser beams comprising said test laser group, whereby said coherent composite laser beam is produced;
a means for directing a first portion of said coherent composite laser beam to a test point located on a test part surface, and a second portion of said coherent composite laser beam to a reference point, resulting in the creation of a reflected test point beam and a reflected reference point beam, wherein said reflected reference point beam and said reflected test point beam are not phase manipulated, and
a means for combining said reflected test point beam and said reflected reference point beam such that an interferometric beam is produced, and
a means for deconvoluting said interferometric beam into a plurality of constituent beams based on frequency, wherein a group of separated beams based on frequency is generated, and
a means for measuring said group of separated beams based on frequency wherein an intensity measurement of at least a portion of said plurality of constituent beams based on frequency is detected and stored, and
a means for determining a metrological differential between said test point and said reference point based on said intensity measurement of at least a portion of said plurality of constituent beams based on frequency.

2. The instantaneous, phase measuring interferometer for metrological analysis of claim 1, wherein said means for generating said test laser group is selected from the group consisting of Lithium Niubate phase modulating systems, and a plurality of laser diode systems.

3. The instantaneous, phase measuring interferometer for metrological analysis of claim 1, wherein said means for combining said one test laser group, is selected from the group consisting of CWDMs, DWDMs, and fiber optics.

4. The instantaneous, phase measuring interferometer for metrological analysis of claim 1, wherein said plurality of simultaneously active individual laser beams each possess substantially identical output intensities further comprising intensity monitoring and feedback correction.

5. The instantaneous, phase measuring interferometer for metrological analysis of claim 1, wherein said crescendo of said unique operating frequencies comprising said test group, includes at least two laser sub-groups, a first sub-group, and a second sub-group, wherein said second sub-group having substantially equal said frequency differential increments, and
said first sub-group is further characterized by a single said simultaneously active coherent laser beam having an unequal said frequency differential increment, thereby providing a sub-group frequency separation between said second sub-group and first said sub-group thereof.

6. The instantaneous, phase measuring interferometer for metrological analysis of claim 1, wherein said interferometer further comprises focusing optics for guiding said test beam to said test part and said reference beam to said reference point, and focusing said reflected test point beam and said reflected reference point beam such that said interferometric beam is produced from the recombination of said reflected beams thereof.

7. The instantaneous, phase measuring interferometer for metrological analysis of claim 1, wherein said means for deconvoluting said interferometric beam is selected from the group consisting of CWDMs, DWDMs, diffraction prisms, and diffraction gratings.

8. The instantaneous, phase measuring interferometer for metrological analysis of claim 1, wherein said means for directing said first portion and said second portion of said coherent composite laser beam is selected from the group consisting of free space beam splitter, and single-mode fiber coupler.

9. The instantaneous, phase measuring interferometer for metrological analysis of claim 1, wherein said means for measuring said interferometric intensity grouping based on frequency is selected from the group consisting of CCD arrays, CMOS arrays, fiber-coupled photo-diode arrays, and open-space photo-diode arrays.

10. The instantaneous, phase measuring interferometer for metrological analysis of claim 1, wherein said coherent composite laser beam passes through a tapered transparent reference plate prior to test part engagement.

11. The instantaneous, phase measuring interferometer for metrological analysis of claim 1, wherein said interferometer further comprises a scanning means for analyzing a plurality of said test points.

12. The instantaneous, phase measuring interferometer for metrological analysis of claim 11, wherein said scanning means for analyzing a plurality of said test points includes a compact probe having a beam splitter contained therein.

13. The instantaneous, phase measuring interferometer for metrological analysis of claim 12, wherein said compact probe further comprising at least one stage-moving-error-correction configuration.

14. The instantaneous, phase measuring interferometer for metrological analysis of claim 1, further comprising a plurality of compact probes, and a means for delivering a portion of said coherent composite laser beam to each of said plurality of compact probes.

15. The instantaneous, phase measuring interferometer for metrological analysis of claim 14, wherein said means for delivering a portion of said coherent composite laser beam to each of said plurality of compact probes further comprising a high speed switch.

16. A method for performing a metrological analysis, using an instantaneous, phase measuring interferometer, comprising the steps of:
(a) producing a coherent composite laser beam, comprised of a means for generating a test laser group configured from a plurality of simultaneously active coherent laser beams each having a unique wavelength and substantially constant intensity output;
(b) combining said test laser group such that each said simultaneously active individual coherent laser beam comprising said test laser group substantially occupies the same physical space;
(c) directing a first portion of said coherent composite laser beam to a test point located on a test part surface, and a second portion of said coherent composite laser beam to a reference point, resulting in the creation of a reflected test point beam and a reflected reference point beam, wherein said reflected reference point beam is not phase manipulated;
(d) combining said reflected test point beam and said reflected reference point beam such that an interferometric beam is produced;
(e) deconvoluting said interferometric beam into a plurality of constituent beams based on frequency, wherein an a group of separated beams based on frequency is generated;
(f) measuring said group of separated beams based on frequency wherein an intensity measurement of at least a portion of said plurality of constituent beams based on frequency is detected and stored;
(g) estimating a proximate distance to a test point based on the pattern of the said intensity measurement;
(h) calculating the interferometric phase value of each separated beam of said group of separated beams based on said proximate distance;
(i) refining said proximate distance to a test point using said phase values;

17. The method of claim 16, wherein steps (g), (h), and (i) are optionally repeated one or more times, each time using a new proximate distance estimate for said estimating a proximate distance to a test point; thereby producing a more accurate proximate distance to a test point.

18. The method of claim 17, wherein steps (g), (h), and (i) are optionally repeated one or more times, each time using a new proximate distance estimate for said estimating a proximate distance to a test point; wherein a triangular calculation method of estimation is utilized.
